(19) United States
(12) Patent Application Publication
(10) Pub. No.: US 2026/0127045 A1
(43) Pub. Date: May 7, 2026

(54) COMMAND MESSAGES FOR HARDWARE ACCELERATORS

(71) Applicant: Arm Limited, Cambridge (GB)

(72) Inventors: Sven Ola Johannes HUGOSSON, Lund (SE); Elliot Maurice Simon ROSEMARINE, London (GB); Alexander Eugene CHALFIN, Mountain View, CA (US)

(21) Appl. No.: 18/939,277

(22) Filed: Nov. 6, 2024

(51) Int. Cl. G06F 9/54; G06F 9/50

(52) U.S. Cl. CPC G06F 9/54; G06F 9/5027; G06F 2209/543

(57) ABSTRACT

An apparatus comprising processing circuitry configured to generate an instruction for configuring a hardware accelerator to perform a task. The instruction comprises a predefined set of fields comprising a control field indicative of a selected set of fields of the predefined set of fields to be provided to the hardware accelerator to configure the hardware accelerator to perform the task. The apparatus comprises accelerator control interface circuitry configured to exchange messages, each with a size less than or equal to a predefined size, with the hardware accelerator. To configure the hardware accelerator to perform the task, the accelerator control interface circuitry is configured to send the selected set of fields to the hardware accelerator, using a set of command messages with a combined size greater than the predefined size. The application further relates to a hardware accelerator.

### BACKGROUND

### Technical Field

The disclosure herein relates to the field of data processing.

### Description of the Related Technology

A data processing system may include at least one hardware accelerator, to which software executing on processing circuitry can offload processing of a delegated task. This can allow the delegated task to be carried out in the background of other tasks being performed by the processing circuitry. A hardware accelerator may comprise hardware circuit logic designed to handle a specific function (such as matrix multiplication, cryptographic processing or manipulation of data structures stored in memory) more efficiently than could be achieved on a general-purpose processor.

### SUMMARY

According to a first aspect of the present disclosure, there is provided an apparatus comprising: processing circuitry configured to generate an instruction for configuring a hardware accelerator to perform a task, wherein the instruction comprises a predefined set of fields comprising a control field indicative of a selected set of fields of the predefined set of fields to be provided to the hardware accelerator to configure the hardware accelerator to perform the task; and accelerator control interface circuitry configured to exchange messages, each with a size less than or equal to a predefined size, with the hardware accelerator, wherein, to configure the hardware accelerator to perform the task, the accelerator control interface circuitry is configured to send the selected set of fields to the hardware accelerator, using a set of command messages with a combined size greater than the predefined size.

According to a second aspect of the present disclosure, there is provided a hardware accelerator comprising: accelerator processing circuitry configurable to perform a task on behalf of a processor; and control interface circuitry configured to exchange messages, each with a size less than or equal to a predefined size, with the processor, wherein the control interface circuitry is configured to receive, from the processor, a set of command messages with a combined size greater than the predefined size; and the accelerator processing circuitry is configured to: obtain, from the set of command messages, a selected set of fields of a predefined set of fields of an instruction to configure the hardware accelerator to perform the task, the selected set of fields comprising a control field indicative of which fields of the predefined set of fields are included in the selected set of fields; and reconstruct the instruction from the set of command messages, based on the control field, to obtain a reconstructed instruction.

### BRIEF DESCRIPTION OF THE DRAWINGS

FIG. 1 is a schematic diagram of an apparatus including a central processing unit (CPU) and a hardware accelerator;

FIG. 2 is a flow diagram of a method of configuring a hardware accelerator to perform a task;

FIG. 3 is a flow diagram of a method of reconstructing an instruction from a set of command messages;

FIG. 4 is a flow diagram of a method of providing an indication of resources to be used by a hardware accelerator to perform a task;

FIG. 5 is a flow diagram of a method of reconstructing a resource instruction from a resource message;

FIG. 6 illustrates an example directed graph;

FIG. 7 is a schematic diagram of a data processing system;

FIG. 8 is a schematic diagram of a neural engine;

FIG. 9 is a schematic diagram of a system for allocating tasks;

FIG. 10 is a schematic diagram of a data structure for storing an instruction;

FIG. 11 is a schematic diagram of a further data structure for storing a resource instruction;

FIG. 12 is a ladder diagram illustrating a transaction communicated between a CPU and a hardware accelerator; and

FIG. 13 is a schematic diagram of manufacture of a system and a chip-containing product.

### DETAILED DESCRIPTION

### Overview of Apparatus and Method

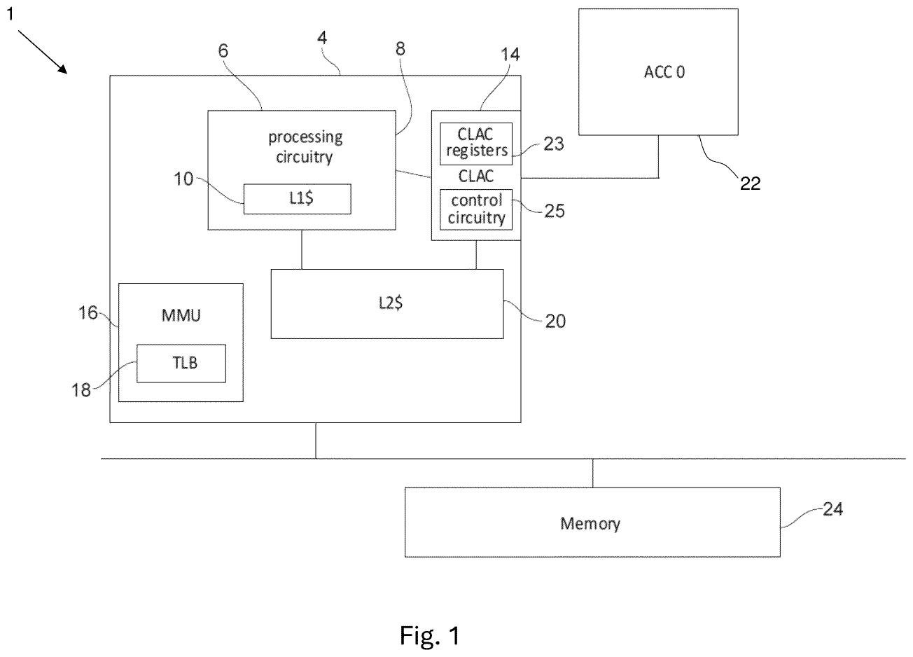

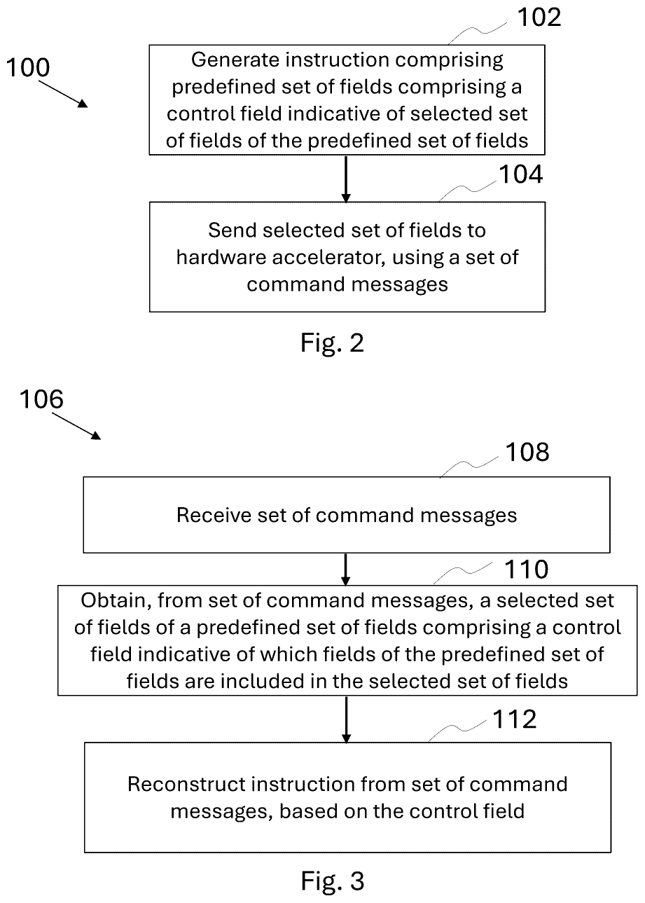

In examples herein, a set of command messages is sent from processing circuitry of an apparatus to a hardware accelerator, to configure the hardware accelerator to perform a task. A suitable apparatus for use in sending messages such as this is shown in FIG. 1. Methods useable in configuring a hardware accelerator to perform a task are then described in more detail with reference to FIGS. 2 to 5.

FIG. 1 schematically illustrates an apparatus 1, which in FIG. 1 is a data processing apparatus, comprising a central processing unit (CPU) 4. The CPU 4 may include one or more processor cores, although only one core is shown in FIG. 1.

The CPU 4 comprises processing circuitry 6 to execute data processing instructions defined in an instruction set architecture (ISA) to carry out data processing operations represented by the data processing instructions. The processing circuitry 6 performs operations on data loaded from a memory system, and may store the results back to the memory system. In this example the memory system includes a level one cache 10, a level two cache 20, and main memory 24, but it will be appreciated that this is just one example of a possible memory hierarchy and other implementations can have further levels of cache or a different arrangement. For example, separate level one caches 10 may be provided for instructions and data. The provision of caches 10, 20 within the CPU 4 enables faster access to data than from memory 24 (which can include on-chip and/or off-chip memory 24).

The CPU 4 also comprises a memory management unit 16 (MMU), to perform address translation in response to memory access instructions executed by the processing circuitry 6. The MMU 16 translates virtual addresses specified by memory access requests into physical addresses identifying storage locations of data in the memory system. The MMU 16 has a translation lookaside buffer (TLB) 18 for caching address translation data from page tables stored in the memory system, where the page table entries of the page tables define the address translation mappings and may also specify access permissions which govern whether a given process executing on the pipeline is allowed to read, write or execute instructions from a given memory region.

The apparatus 1 also includes a hardware accelerator 22. The hardware accelerator 22 is configurable, based on an instruction generated by the processing circuitry 6, to perform a task. The task may be a delegated task, which is performed asynchronously by the hardware accelerator 22 with respect to operations performed by the processing circuitry 6. In FIG. 1, the hardware accelerator 22 is unique (private) to a single processor core 4, and therefore may be referred to as a core local accelerator (CLA). The hardware accelerator 22 is controlled by, and communicates with the memory system via, an associated processor core. The CPU 4 therefore comprises accelerator control interface circuitry 14 (a core local accelerator control module (CLAC)) to exchange messages, such as command messages and resource messages, with the hardware accelerator 22 to control the hardware accelerator 22. The messages exchanged between the accelerator control interface circuitry 14 and the hardware accelerator 22 each have a size less than or equal to a predefined size and are exchanged in this case via control circuitry 25 of the accelerator control interface circuitry 14. For example, a transaction (e.g. corresponding to a message) sent between the accelerator control interface circuitry 14 and the hardware accelerator 22 may be formed of up to eight words, each of up to eight bytes (B) in length. The accelerator control interface circuitry 14 and the hardware accelerator 22 in this example can thus exchange messages that each have a size of up to 64 B in total.

The hardware accelerator 22 accesses the memory system via the CPU 4, and issues accelerator-triggered memory access requests using virtual addresses. In response to an accelerator-triggered memory access request received at the accelerator control interface circuitry 14 from the hardware accelerator 22, the MMU 16 translates a virtual address specified by the accelerator-triggered memory access request to a physical address of a memory system location to be accessed in response to the accelerator-triggered memory access request.

The processing circuitry 6 supports execution of accelerator control instructions in an ISA, separate from load/store instructions, for controlling the accelerator control interface circuitry 14 to perform functions such as launching accelerator commands, checking on accelerator status, reading internal accelerator state, writing other accelerator control registers, etc. In FIG. 1, the processing circuitry 6 is configured to generate an instruction for configuring the hardware accelerator 22, via the accelerator control interface circuitry 14, to perform a task. The instruction may be generated in response to execution of accelerator control instructions by the processing circuitry 6, and sent to the hardware accelerator 22 by the accelerator control interface circuitry 14 using a set of command messages as discussed further with reference to FIG. 2.

However, in other examples, the CPU 4 may comprise memory-mapped register storage accessible in response to load/store instructions executed by the processing circuitry 6 specifying target addresses mapped to the memory-mapped register storage. Hence, accelerator commands may be triggered by execution of load/store instructions which specify addresses mapped to the memory-mapped register storage, illustrated in FIG. 1 as the “CLAC registers” 23. The CPU 4 (via the accelerator interface circuitry 14) may control operation of the hardware accelerator 22 by writing to and reading from the memory-mapped register storage. Hence, the processing circuitry 6 in these examples can control operation of a hardware accelerator 22 using conventional load/store instructions (with the address of the load/store instructions distinguishing accelerator control instructions from other load/store instructions targeting locations in the memory system 10, 20, 24). This may be the case where the CLAC registers 23 are sufficiently large to store the load/store instructions for configuring the hardware accelerator 22. In these examples, the load/store instructions may be considered to be or comprise an instruction generated by the processing circuitry 6 for configuring the hardware accelerator 22 to perform a task.

The CLAC registers 23 may comprise a LAUNCH register (not shown in FIG. 1). The processing circuitry 6 can cause accelerator control signals (such as command messages and/or resource messages) to be issued to a given hardware accelerator 22 by writing to the LAUNCH register. Writing different values to the LAUNCH register can be used to indicate that the processing circuitry 6 requests the hardware accelerator control interface circuitry 14 to initiate different operations for performance by the hardware accelerator 22. For example, the LAUNCH register may comprise a launch operation type field (e.g. provided by bits [3:0] of the LAUNCH register) identifying a particular operation type. A launch payload size field may be provided by bits [6:4] of the LAUNCH register, the launch payload size field identifying, for operations involving transactions supporting a variable number of payload words, a number of payload words of the transaction (which payload words may be obtained from a set of DATA registers of the CLAC registers 23 (not shown in FIG. 1)). A sequence indicator field “seq” may be provided by bit [7] of the LAUNCH register, the sequence indicator field supporting the use of compound commands, as discussed below with reference to FIG. 12. In FIG. 1, the apparatus 1 has a single hardware accelerator 22 coupled to the CPU 4. However, in other examples, an apparatus otherwise similar to or the same as the apparatus 1 of FIG. 1 may include a plurality of hardware accelerators coupled to the CPU 4. In such cases, a target hardware accelerator identifying field may be provided by bits [10:8] of the LAUNCH register, which identifies a target hardware accelerator for the operation.

In the example of FIG. 1, the CLAC registers 23 (e.g. the DATA registers of the CLAC registers 23) are not large enough to store an instruction for configuring the hardware accelerator 22 to perform a particular task. In FIG. 1, a storage size of the DATA registers is less than a bit-length of a predefined set of fields of the instruction. In this example, there are 8 DATA registers, each with a storage size of 64 b for storing one message to be sent to the hardware accelerator 22, i.e. so that the total storage size of the DATA registers is 512 b (64 B). The CLAC registers 23 comprise the DATA registers in FIG. 1. The DATA registers allow a set of messages with a payload of up to 64 B to be sent from the CLAC registers 23 to the hardware accelerator 22. In the example of FIG. 1, the packet header has a size of 64 b, and the payload has a size of up to 64 B, meaning that each set of messages allows up to 72 B of data to be sent to the hardware accelerator 22. However, the bit-length of the predefined set of fields is larger than this in FIG. 1 and may be, for example, 640 B or 320 B. To address this, approaches herein comprise identifying a selected set of fields of the predefined set of fields for sending to the hardware accelerator 22, so as to reduce the size of the data to be sent to the hardware accelerator 22 (and to be stored in the DATA registers), as explained further with reference to FIG. 2. For example, the selected set of fields may have a bit-length greater than the predefined size of messages exchanged between the accelerator control interface circuitry 14 and the hardware accelerator 22 (i.e. a bit-length of greater than 8 B in the example of FIG. 1). However, the selected set of fields may have a bit-length of less than or equal to the (combined) storage size of the DATA registers (i.e. a bit-length of less than or equal to 64 B), so that each of the selected set of fields may be stored concurrently in the DATA registers.

As explained in more detail with reference to FIG. 12, there may be various types of command messages, such as command-with-response (CMD) messages indicating that the hardware accelerator 22 is to acknowledge the command-with-response message and command-without-response messages (CMDNR) indicating that the hardware accelerator 22 does not need to acknowledge the command-without-response message. In FIG. 1, the packet header for a particular command message specifies the type of message, e.g. whether it's a CMD message, a CMDNR message or another type of message. The packet header also indicates the size of the payload to be included in the message. Data for the packet header in FIG. 1 is stored in various fields of the LAUNCH register (such as the launch operation type field, launch payload size field, sequence indicator field etc.), prior to sending the command message to the hardware accelerator 22, as discussed further above. The format of the packet header is defined by a control request channel (CREQ) for sending messages from the CPU 4 to the hardware accelerator 22, as described further with reference to FIG. 2, and in this example is independent of the nature of the command message. The messages sent from the CPU 4 to the hardware accelerator 22 and vice versa may thus be considered to be CREQ packets. In other words, writing to the LAUNCH register triggers packets to be sent via the CREQ channel to initiate an operation with a packet type specified by bits [3:0] of the LAUNCH register, for example CMD, CMDNR, RESET, REGREAD, REGWRITE etc. Bits [6:4] of the LAUNCH register specify how much payload to include (in this case, how many of the DATA registers to include). So, this 3 b field can be 0-7, but is interpreted as 1-8 so that the encoded value is −1 from the real value. Various packet types, such as CMD, CMDNR, REGREAD, REGWRITE can have a variable payload size so that is indicated in bits [6:4] of the LAUNCH register. Other packet types, such as RESET, do not have a payload, so have a value of 0 for bits [6:4] (which is interpreted as 0 not 1 for these packet types).

In examples, there may be a predefined limit to the number of CMDNR messages that are sent before a CMD message is sent. For example, there may be 7 CMDNR messages followed by 1 CMD message, giving a total payload of (7+1)*64 B=512 B to be sent using the set of 8 command messages (formed of 7 CMDNR messages and 1 CMD message). The predefined limit may be set to a particular value so that the entirety of an instruction to configure the hardware accelerator 22 to perform a task can be fitted within a single set of command messages. For example, in another case, 4 CMDNR messages may be sent before 1 CMD message is sent, amounting to a total payload of (4+1)*64 B=320 B, e.g. if the size of the instruction is less than or equal to 320 B. In these examples, the hardware accelerator 22 has sufficient storage capacity to store the set of command messages (i.e. a storage capacity of 512 B for the example with a set of 7 CMDNR messages followed by 1 CMD message or a storage capacity of 320 B for the example with a set of 4 CMDNR messages followed by 1 CMD message). However, the DATA registers of the CLAC registers 23 in FIG. 1 have a lower storage capacity than this (of 64 B).

FIG. 2 is a flow diagram of a method 100 of configuring a hardware accelerator 22 to perform a task, which may be performed by the CPU 4 of FIG. 1. The hardware accelerator 22 may have a particular structure that is designed specifically for the performance of particular functionality for executing the task. This can enable the hardware accelerator 22 to perform the task more efficiently than the processing circuitry 6 (which in the example of FIG. 1 is processing circuitry of the CPU 4, which is a general-purpose processor). For example, the hardware accelerator may be a neural network accelerator (which may be referred to as a neural engine) configured for efficient performance of functionality involved in the execution of a neural network. In such cases, the task may comprise at least a portion of a neural processing operation, for example to implement at least a portion of a neural network, which can be performed in an effective manner using the neural network accelerator.

In the method 100 of FIG. 2, the processing circuitry 6 is configured to exchange messages with the hardware accelerator 22, via the accelerator control interface circuitry 14. The messages are used to configure the hardware accelerator 22 to perform the task, and may also be used for further configuration of the hardware accelerator 22 (e.g. in the performance of other tasks). The messages exchanged may include messages from the hardware accelerator 22 to the processing circuitry 6 to communicate a status of the hardware accelerator 22. Status messages from the hardware accelerator 22 may be utilized by the processing circuitry 6 in appropriately controlling the hardware accelerator 22 (and/or at least one further hardware component) to enable particular tasks to be performed. For example, the processing circuitry 6 may configure the hardware accelerator 22 to perform the task in response to a message from the hardware accelerator 22 indicating that the hardware accelerator 22 is available.

There may be two groups of channels between a CPU 4 (or other component comprising or otherwise corresponding to the processing circuitry) and the hardware accelerator 22: control channels and memory interface channels. The control channels may comprise a control request channel (CREQ) and a control response channel (CRSP). The memory interface channels may comprise a read address channel (RD_AR), a read data channel (RD_R), a write address channel (WR_AW), a write data channel (WR_W), and a write response channel (WR_B). In some examples, multiple read and/or write channels may be supported, and hence for example two or more copies of the RD_AR and RD_R channels may be provided, and so on.

The CREQ channel may be used to carry messages from the CPU 4 to the hardware accelerator 22. The CRSP channel may be used to carry messages from the accelerator 22 to the CPU 4. The CPU 4 may initiate transactions on the control channels to launch accelerator commands, access accelerator registers, pause or reset the accelerator, save or restore accelerator state, and to resume the accelerator after an exception or pause. The transactions sent by the CPU 4 in accordance with the method 100 of FIG. 2 include command messages to configure the hardware accelerator 22 to perform the task, and may additionally include at least one resource message. The hardware accelerator 22 may initiate transactions on the control channels to inform the CPU 4 about accelerator status changes. The transactions sent by the hardware accelerator 22 may include a response message in response to a message received from the processing circuitry 6, such as command or resource message.

As explained above, the messages exchanged between the accelerator control interface circuitry 14 and the hardware accelerator 22 each have a size less than or equal to a predefined size. In examples herein, task data (e.g. corresponding to an instruction) to configure the hardware accelerator 22 to perform a task may have a size that exceeds the predefined size. To send task data with a size of 80 8 Bs, for example, it would take 10 transactions of eight 8 B words (e.g. 10 messages). It may therefore take a relatively long time to send the task data to the hardware accelerator 22 to configure the hardware accelerator 22 to perform a task.

The method 100 of FIG. 2 for example enables the hardware accelerator 22 to be configured more efficiently to perform a task by reducing the amount of data sent to the hardware accelerator 22 (in the form of command messages) to configure the hardware accelerator 22 to perform the task.

At block 102 of the method 100, an instruction is generated for configuring the hardware accelerator 22 to perform the task. The instruction may be generated by the processing circuitry 6 of the apparatus 1. The instruction comprises a predefined set of fields. For example, the instruction may be in the form of a predefined data structure comprising the predefined set of fields, for storing task data indicative of the task. Values of respective fields for example indicate a nature of the task that is to be performed by the hardware accelerator 22, so that different tasks may be indicated by adjusting the values of respective fields of the predefined set of fields, without changing the underlying data structure used for the instruction.

However, it may not be necessary to provide each field of the predefined set of fields to the hardware accelerator 22 in order to configure the hardware accelerator 22 to perform a particular task. In some cases, at least one of the predefined set of fields may take a predefined value, such as a null value or 0. In these cases, the predefined value(s) need not be provided to the hardware accelerator 22 in order to configure the hardware accelerator 22 to perform the task, allowing a reduced amount of data to be sent to the hardware accelerator 22 than otherwise.

This is the case in the method 100 of FIG. 2, in which the predefined set of fields of the instruction comprises a control field indicative of a selected set of fields of the predefined set of fields to be provided to the hardware accelerator 22 to configure the hardware accelerator 22 to perform the task. The selected set of fields may correspond to the fields of the predefined set of fields that comprise non-trivial values (e.g. values that differ from a predefined, null, 0 or otherwise default value). The selected set of fields may thus differ for different tasks, depending on the nature of the task. If the predefined set of fields comprises a first subset of fields, each having a non-zero value, and a second subset of fields, each having a zero value, the first subset of fields may be chosen as the selected set of fields, which are to be sent to the hardware accelerator 22. Sending of the second subset of fields (e.g. the non-selected set of fields) to the hardware accelerator 22 may be omitted without affecting performance of the task. The second subset of fields may for example be skipped in generating command message(s) for sending to the hardware accelerator 22 to configure the hardware accelerator 22 to perform the task.

The processing circuitry 6 determines how to distribute the selected set of fields across a set of command messages. For example, the processing circuitry 6 may determine to include a first set of the selected set of fields in a first command message of the set of command messages, and a second set of the selected set of fields in a second command message of the set of command messages. A size of each of the command messages need not be the same (but may be). For example, a first size of the first command message may be different from a second size of the second command message. As a further example, if the selected set of fields is made up of 9 words of 8 B each, the processing circuitry 6 may determine that these 9 words are to be sent as one transaction (e.g. the first command message) of 8 words, and one transaction (e.g. the second command message) of 1 word, or that the 9 words are to be sent using first and second command messages of 1 and 8 words, respectively, or 5 and 4 words, respectively, or that the 9 words are to be sent using three transactions (e.g. three command messages) each of 3 words, and so forth. This allows the processing circuitry 6 to build up the set of command messages piecemeal, and send respective command messages to the hardware accelerator 22 as they are ready, providing flexibility in configuring the hardware accelerator 22 to perform the task.

At block 104, the selected set of fields are sent to the hardware accelerator 22. The selected set of fields are sent to the hardware accelerator 22, for example by the accelerator control interface circuitry 14, using a set of command messages with a combined size greater than the predefined size. The combined size of the selected set of fields may be too large to send the selected set of fields as a single transaction. The selected set of fields may instead be sent using a set of command messages (e.g. using a plurality of transactions), each of which has a size less than or equal to the predefined size. The set of command messages together have a combined size greater than the predefined size. The combined size of the set of command messages is for example less than a combined size of the predefined set of fields, as the selected set of fields (forming the set of command messages) corresponds to a subset of the predefined set of fields, reducing the amount of data sent from the accelerator control interface circuitry 14 to the hardware accelerator 22. This may enable the hardware accelerator 22 to be configured using fewer messages from the accelerator control interface circuitry 14, allowing the hardware accelerator 22 to be configured, and the task performed, more efficiently.

As noted above, the fields of the predefined set of fields that are included in the selected set of fields by the processing circuitry 6 may vary for different tasks. This may lead to a variation in the combined size of the command messages (which comprise the selected set of fields) sent to the hardware accelerator 22 between different tasks. This may allow the combined size to be adjusted in a flexible manner, to efficiently instruct the hardware accelerator 22 to perform the task.

The set of command messages may be considered to be of a particular type with a size that is permitted to vary for different tasks. In contrast, a size of at least one other type of message from the accelerator control interface circuitry 14 to the hardware accelerator 22 (e.g. to further aid in configuring the hardware accelerator 22 to perform a given task) may be non-varying, e.g. constant, for different tasks. For example, the size of the at least one other type of message may be independent of the task to be performed. The type of a given message may be indicated in at least one field of the given message. In an example, the payload of a given message (written to a DATA register) includes a configuration message type field in which the final 4 bits (b) of the first word (bits [63:60]) convey the type of the configuration initiated by the message, e.g. by indicating whether the message is a command message or a resource message. It is to be appreciated that the configuration message type field indicates the nature of the configuring or triggering of the hardware accelerator 22 initiated by the message, such as whether the message configures the hardware accelerator 22 to perform a particular task or whether the message is for configuring the hardware accelerator 22 to use particular resources to perform a particular task. This is distinct from the type indicated by the launch operation type field written to the LAUNCH register, which may be considered a packet type indicative of the nature of the message (e.g. whether it is a CMD, CMDNR, RESET, REGREAD, REGWRITE etc. message) but without indicating how the hardware accelerator 22 is configured by the message.

If a set of command messages is sent to the hardware accelerator 22 as a set of CMDNR/CMD messages, the message type from bits [63:60] of the first DATA register only applies for the first CMDNR/CMD message in the set of messages. So, in a first example in which 9 8 B words are sent as 2 packets (one CMDNR message followed by one CMD message), for the first, CMDNR, message: data is written to the LAUNCH register with bits [3:0] indicating that the first message is a CMNDNR message and bits [6:4]==4, indicating that data is to be sent from 5 DATA registers, and with bits [63:60] of the payload stored in the DATA registers indicating that the message is a command message to configure the hardware accelerator to perform a particular task and bits [39:0] of the payload stored in the DATA registers corresponding to the control field indicative of the selected set of fields to be sent to the hardware accelerator 22 and having 9 bits set. In this first example, for the second, CMD, message; data is written to the LAUNCH register with bits [3:0] indicating that the second message is a CMD message and bits [6:4]==3, indicating that data is to be sent from 4 DATA registers (i.e. to send 9 8 B words in total, over the two messages).

In a second example in which 9 8 B words are sent as 3 packets (two CMDNR messages followed by one CMD message), for the first, CMDNR, message: data is written to the LAUNCH register with bits [3:0] indicating that the first message is a CMNDNR message and bits [6:4]==2, indicating that data is to be sent from 3 DATA registers, and with bits [63:60] of the payload stored in the DATA registers indicating that the message is a command message to configure the hardware accelerator to perform a particular task and bits [39:0] of the payload stored in the DATA registers corresponding to the control field indicative of the selected set of fields to be sent to the hardware accelerator 22 and having 9 bits set. In this second example, for the second, CMDNR, message; data is written to the LAUNCH register with bits [3:0] indicating that the second message is a CMDNR message and bits [6:4]==2, indicating that data is to be sent from 3 DATA registers. For the third, CMD, message; data is written to the LAUNCH register with bits [3:0] indicating that the third message is a CMD message and bits [6:4]==2, indicating that data is to be sent from 3 DATA registers.

In these examples, writing the LAUNCH register triggers the sending of CREQ packets with bits with values corresponding to the bits (and values) stored in the LAUNCH register. In other words, bits [3:0] of a particular CREQ packet indicates whether a particular message is a CMD or CMDNR message (or another packet type) and bits [6:4] indicates the size of the payload associated with the CREQ packet.

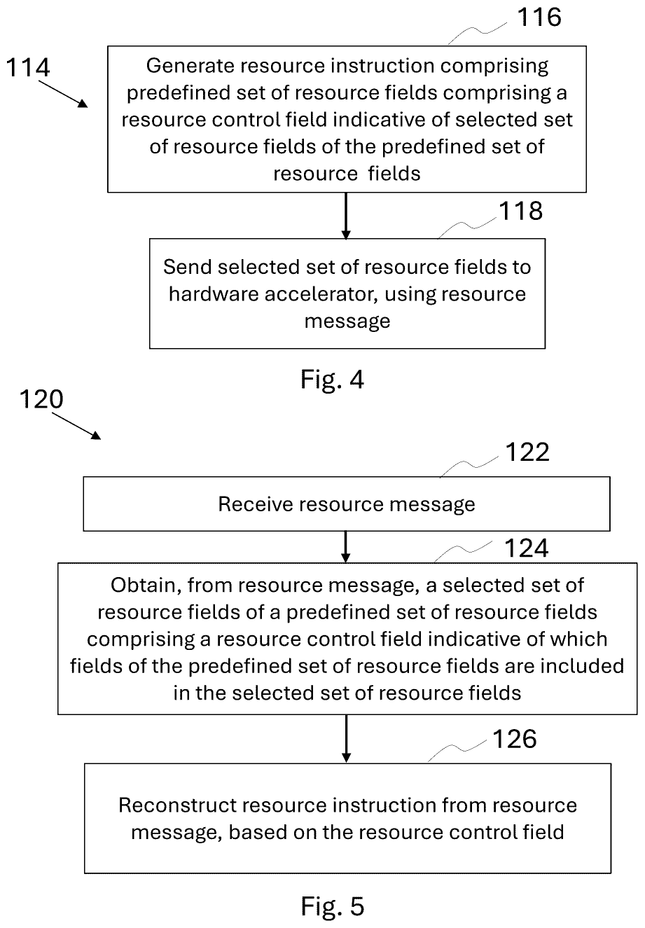

In an example, the instruction to configure the hardware accelerator 22 to perform a particular task has a size of 320 B, resulting in command messages (comprising a selected set of fields of the instruction) sent to the hardware accelerator 22 with a combined size of less than 320 B (and with an actual combined size that depends on the particular task to be performed, and which may differ for different tasks). In this example, the accelerator control interface circuitry 14 also sends at least one further configuration message, each with a fixed size of a single 8 B word, to the hardware accelerator 22 to further aid in configuring the hardware accelerator 22 for the execution of the task or for triggering other behaviour in the hardware accelerator 22. The accelerator control interface circuitry 14 may send a resource message to the hardware accelerator 22 indicative of resources to be used by the hardware accelerator 22 to perform the task. The resource message may have a fixed size. In this example, the resource message has a fixed size of seven 8 B words, i.e. 56 B in total. Alternatively, the resource message may also depend on the task to be performed, as explained further below with reference to FIGS. 4 and 5.

The accelerator control interface circuitry 14 may indicate an extent of a transaction which is valid. For example, the accelerator control interface circuitry 14 may indicate how many words of a multi-word message are valid in a transaction. In the example above, this is 1 for the at least one further configuration message (indicating that the 1 8 B word of the at least one further configuration message is valid), and 7 for the resource message (indicating that the 7 8 B words of the resource message are valid). In this example, the at least one further configuration message and the resource message have a combined size which is equal to the predefined size of messages exchanged between the accelerator control interface circuitry 14 and the hardware accelerator of eight 8 B words. This allows the at least one further configuration message and the resource message to be sent in a single transaction (e.g. a single combined message) from the accelerator control interface circuitry 14 to the hardware accelerator 22.

FIG. 3 is a flow diagram of a method 106 of reconstructing an instruction from a set of command messages, such as those sent at block 104 of FIG. 2. The method 106 of FIG. 3 may be performed by the hardware accelerator 22 of FIG. 1.

Block 108 of the method 106 comprises receiving the set of command messages. The set of command messages are for example received by the hardware accelerator 22, e.g. by control interface circuitry, from the accelerator control interface circuitry 14. The control interface circuitry is for example configured to exchange messages, each with a size less than or equal to a predefined size, with a processor (e.g. with the accelerator control interface circuitry 14 of a CPU 4), to enable the hardware accelerator 22 to communicate with the processor. The set of messages received by the hardware accelerator 22, e.g. by the control interface circuitry, have a combined size greater than the predefined size.

Block 110 of the method 106 comprises obtaining, from the set of command messages, a selected set of fields of a predefined set of fields of an instruction to configure the hardware accelerator to perform the task. The selected set of fields are those sent in the set of command messages by the processor, and for example represent non-zero values (or values that are otherwise not predefined, null or default values) indicative of the task to be performed by the hardware accelerator 22.

The selected set of fields comprise a control field indicative of which fields of the predefined set of fields are included in the selected set of fields. At block 112 of the method 106, the instruction is reconstructed from the set of command messages, based on the control field, to obtain a reconstructed instruction. For example, as the control field indicates which fields of the predefined set of fields are included in the selected set of fields, the hardware accelerator 22 can determine which fields of the predefined set of fields are omitted from the fields sent in the set of command messages. To recreate the reconstructed instruction, the hardware accelerator 22 can then add these omitted fields back in, to re-generate the predefined set of fields (formed of the selected set of fields received in the set of command messages and the fields that the hardware accelerator 22 has determined, from the control field, were missing from the set of command messages). The hardware accelerator 22 may then assign predefined values to each of these so-called “missing” (or otherwise skipped or non-selected) fields of the reconstructed instruction. The predefined values are for example 0 or another null value but, in other cases, the predefined values may instead be another predefined non-zero value.

In this way, the hardware accelerator 22 can reconstruct the instruction from the set of command messages, without the instruction being sent in its entirety to the hardware accelerator 22. This allows the hardware accelerator 22 to be configured to perform the task more efficiently, for example with fewer transactions between the processor and the hardware accelerator 22, than otherwise.

Blocks 110 and/or 112 of the method 106 of FIG. 3 may be performed by accelerator processing circuitry of the hardware accelerator 22, which is configurable to perform a task on behalf of the processor, e.g. the CPU 4.

In an example, the set of command messages received at block 108 of the method 106 of FIG. 3 includes a first message comprising the control field and at least one subsequent message (e.g. including a second message subsequent to the first message). In this example, the hardware accelerator 22 (for example, the accelerator processing circuitry) can use the control field of the first message to determine which fields of the predefined set of fields are included in the first message and the at least one subsequent message. The hardware accelerator 22 may have suitable logic to keep track of a position of respective messages of the set of messages within the context of the instruction as a whole, e.g. to recall whether a particular message is partway through a particular instruction or not. For example, the hardware accelerator 22 may be configured to implement a state machine to keep track of the control field and the messages received, to determine whether a particular message is to be treated as a first word (e.g. an initial word) of a new instruction or a subsequent word of an instruction that is partly reconstructed in accordance with the control field.

In order to configure a hardware accelerator 22 to perform a task, at least a portion of a configuration of the hardware accelerator 22 may be unlikely to change for different tasks. In examples, the processing circuitry 6 may be configured to separate configuration instructions for configuring the hardware accelerator 22 to perform the task into a plurality of portions, which are each associated with a different likelihood of changing in dependence on the task. In these examples, the processing circuitry 6 may separate a first portion of the configuration instructions, which is more likely to change, from a second portion of the configuration instructions, which is less likely to change, and use separate messages (or sets of messages) to send the first and second portions, which may allow the hardware accelerator 22 to be configured more efficiently to perform the task. For example, the instruction generated at block 102 of the method 100 of FIG. 2 may correspond to the first portion of the configuration instructions, which is more likely to change depending on the task to be performed. For example, this instruction may comprise task-specific fields that typically vary based on the task. However, resources, for example representing a location of data to be utilized in performing a task, may be unlikely to change for different tasks. This may be the case if the same data (or a respective portion thereof) is processed for various different tasks. Resources (e.g. corresponding to the second portion of the configuration, which is less likely to change depending on the task to be performed) may thus be indicated separately to the hardware accelerator 22 from the instruction itself, via a resource message. The resource message may be stateful, and may set up a state (e.g. corresponding to particular resources) at the hardware accelerator 22 that can be used in performing the task and subsequent tasks. Subsequent tasks may cause a modification of at least part of the state, such as at least a subset of the resources indicated by the resources message, at the hardware accelerator 22. However, the set of command messages based on the instruction may not set up a corresponding state at the hardware accelerator 22, as the hardware accelerator 22 may not re-use the reconstructed instruction obtained based on the set of command messages for performing subsequent tasks.

FIG. 4 is a flow diagram of a method 114 of providing an indication of resources to be used by a hardware accelerator 22 to perform a task, which may be performed by the CPU 4 of FIG. 1. At block 116, a resource instruction indicative of resources to be used by the hardware accelerator 22 to perform the task is generated, for example by the processing circuitry 6. A resource message based on the resource instruction may be sent to the hardware accelerator 22, e.g. by the accelerator control interface circuitry 14, to configure the hardware accelerator 22 to use the resources to perform the task.

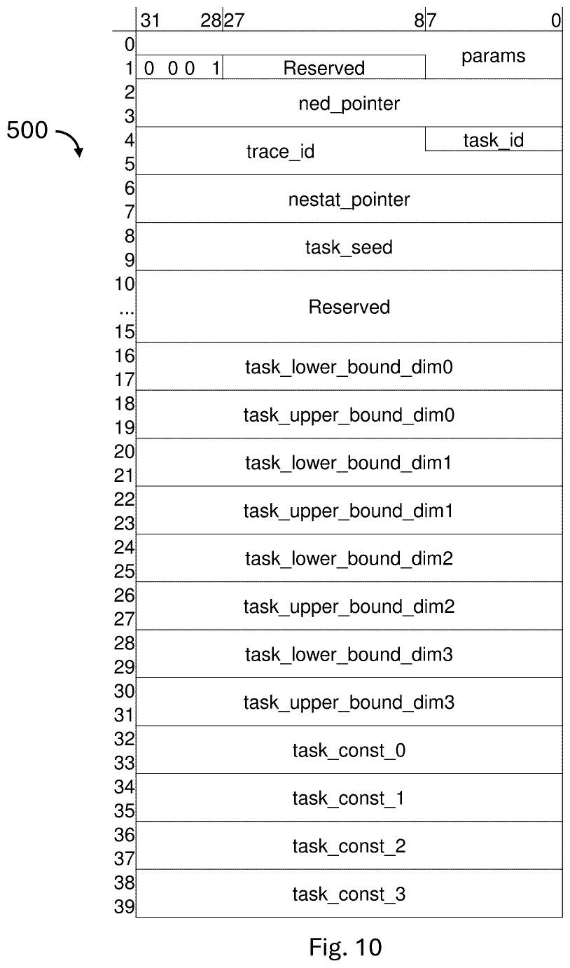

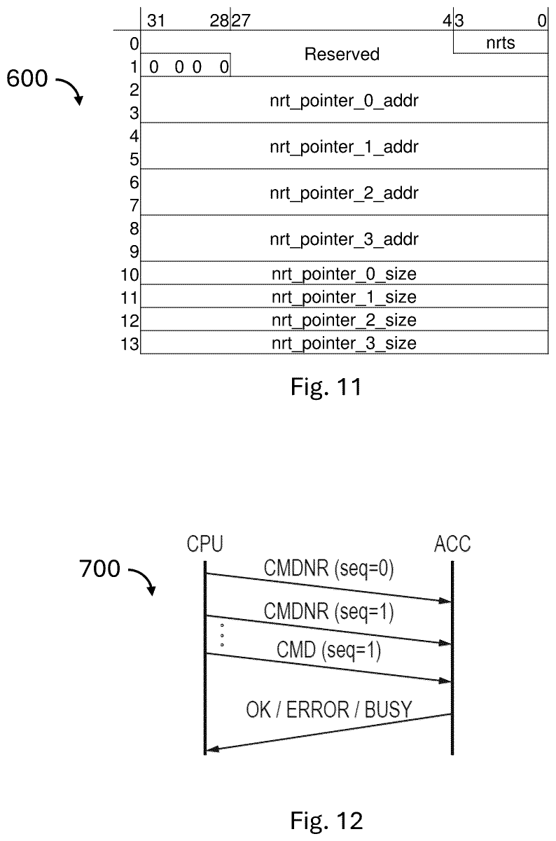

The resources may be in various formats, depending on the task. In an example, the task is a neural processing task, comprising processing a portion of a multi-dimensional tensor as discussed further below with reference to FIGS. 10 and 11. In this example, the resources provide a configuration for at least one table comprising tensor descriptors, each indicative of a respective portion of a tensor. A tensor descriptor for a given tensor may be or comprise a pointer to an address of the given tensor in storage (e.g. of the apparatus 1, such as the level two cache 20 or a dynamic random access memory (DRAM) of the apparatus 1, which is not shown in FIG. 1). The pointer corresponding to the tensor descriptor may be referred to as a tensor base pointer, which may be indicative of the physical address in the storage from which storage of the portion of the tensor begins. In other cases, though, a tensor base pointer may indicate the physical address in the storage of a particular element of the portion of the tensor, which may be offset from the start of the portion of the tensor but which nevertheless allows the start of the portion of the tensor to be located within the storage.

The resource instruction in this example may comprise a pointer to a resource table base address for each of the at least one table (each comprising a respective set of tensor descriptors). The resource table base address for a given table for example indicates a physical location in storage (e.g. of the apparatus 1, such as the level two cache 20 or a DRAM) at which the given table (or a particular entry thereof) is stored. For example, the resource table base address may indicate the physical address in the storage from which storage of the given table begins. In other cases, though, the resource table base address may indicate the physical address in the storage of a particular element of the given table, which may be offset from the start of the given table but which nevertheless allows the start of the given table to be located within the storage. The at least one table and the tensors themselves may be stored in the same storage as each other, or in different storage components.

In this case, at least one field of the instruction may point to a particular table number and table index, to point to a particular tensor descriptor stored in the table with the particular table number and at the position within the table indicated by the table index. The tensor descriptor can be obtained by the hardware accelerator 22, based on the resource message, from the correct physical location in storage by using the pointer to the resource table base address (as indicated by the resource message) for the table with the particular table number. The hardware accelerator 22 can then determine the physical address of the particular tensor descriptor based on the position of the particular tensor descriptor within the particular table, relative to a position within the particular table at the resource table base address. This allows the particular tensor descriptor to be obtained, which provides a pointer to the physical location of the portion of the tensor described by the tensor descriptor. The portion of the tensor itself can then be obtained by the hardware accelerator 22 from the physical location in the storage indicated by the pointer represented by the particular tensor descriptor. The portion of the tensor can then be processed by the hardware accelerator 22 to perform the task.

In the context of FIG. 4, rather than the accelerator control interface circuitry 14 sending the resource instruction generated by the processing circuitry 6 to the hardware accelerator 22 based on the resource message (e.g. by sending the resource instruction as the resource message), the method 114 of FIG. 4 comprises reducing the data sent to the hardware accelerator 22 in a similar manner to that described for the instruction in the method 100 of FIG. 2. In particular, at block 116 of FIG. 4, the resource instruction comprises a predefined set of resource fields comprising a resource control field indicative of a selected set of resource fields of the predefined set of resource fields to be provided to the hardware accelerator 22 for configuring the hardware accelerator to use the resources to perform the task. The resource instruction may be a predefined data structure comprising the predefined set of resource fields for storing resource data indicative of the resources (such as pointers to resource tables or elements thereof). The values of respective fields of the predefined set of resource fields may differ for different tasks but are generally likely to persist (e.g. to be the same) for at least some different tasks. Nevertheless, it may not be necessary to provide each of the predefined set of resource fields to the hardware accelerator 22, e.g. if they take a predefined value, such as a null value or 0, and/or if they point to resources that are unchanged compared to previous tasks performed by the hardware accelerator 22. This is the case in the method 114 of FIG. 4, in which the processing circuitry 6 configures the resource control field to indicate the selected set of resource fields which are to be provided to the hardware accelerator 22 (such as those with values that have changed with respect to a previous task performed by the hardware accelerator 22).

At block 118 of the method 114, the selected set of resource fields are sent to the hardware accelerator 22 using the resource message, e.g. by accelerator control interface circuitry 14. The resource fields that are not comprised by the selected set of resource fields may be omitted from the resource message, so as to reduce the data sent.

FIG. 5 is a flow diagram of a method 120 of reconstructing a resource instruction from a resource message, such as that sent at block 118 of FIG. 4. The method 120 of FIG. 5 may be performed by the hardware accelerator 22 of FIG. 1.

Block 122 of the method 120 comprises receiving the resource message. The resource message is for example received by the hardware accelerator 22, e.g. by control interface circuitry, from the accelerator control interface circuitry 14. In FIGS. 4 and 5, as in FIGS. 2 and 3, the accelerator control interface circuitry 14 and the hardware accelerator 22 are configured to exchange messages, each with a size less than or equal to the predefined size.

If the resource message is the resource instruction (and e.g. includes all of the fields of the resource instruction), the hardware accelerator 22 can obtain the resources indicated by the resource instruction without further processing of the resource message. However, in FIG. 5, block 124 of the method 120 comprises obtaining, from the resource message, a selected set of resource fields of a predefined set of resource fields of a resource instruction to configure the hardware accelerator 22 to use resources indicated by the resource instruction to perform a task. The selected set of resource fields are those sent in the resource message by the processor.

The selected set of resource fields comprise a resource control field indicative of which fields of the predefined set of resource fields are included in the selected set of resource fields. At block 126 of the method 120, the resource instruction is reconstructed from the resource message, based on the resource control field, to obtain a reconstructed resource instruction, for example in an analogous manner to reconstructing the instruction as described with reference to block 112 of FIG. 3. For example, as the resource control field indicates which fields of the predefined set of resource fields are included in the selected set of resource fields, the hardware accelerator 22 can determine which fields of the predefined set of resource fields are omitted from the fields sent in the resource message. To recreate the reconstructed resource instruction, the hardware accelerator 22 can then add these omitted fields back in, to re-generate the predefined set of resource fields (formed of the selected set of resource fields received in the resource message and the fields that the hardware accelerator 22 has determined, from the resource control field, were missing from the resource message). The hardware accelerator 22 may then assign predefined values to each of these so-called “missing” (or otherwise non-selected) fields of the reconstructed resource instruction. The predefined values may for example be the values of those fields for a previously executed task (e.g. if the unselected set of fields are for those resources that are unchanged).

The resources indicated by the reconstructed resource instruction (or the resource instruction itself, if no reconstruction is performed, e.g. if the resource instruction is sent as the resource message) may be stored by the hardware accelerator 22 and re-used for subsequent tasks as described above. For example, the accelerator processing circuitry may be configured to use the resources indicated by the resource message to perform a first task, and to perform a second task subsequent to the first task.

### Execution of a Directed Graph

The methods 100, 106, 114, 120 of FIGS. 2 to 5 may be used to execute a neural processing task, for example comprising at least a portion of a neural processing operation. In an example, neural networks can be represented as a directed graph of operations that wholly compose the operations required to execute a network (i.e. to execute the operations performed across the layers of a neural network). A directed graph is a data structure of operations (which may be referred to herein as ‘sections’) having directed connections therebetween that indicate a flow of operations. The connections between operations (or sections) present in the graph of operations may be referred to as pipes (where a given connection is the sole tenant of a particular region of storage of a particular hardware accelerator for executing neural network processing, which region may be allocated to that connection statically or dynamically) or sub-pipes (where a given connection shares a particular region of the storage with at least one other connection). The allocation of particular storage elements within a given region of the storage unit to different respective sub-pipes that are tenants of the given region of the storage unit may be performed dynamically. A plurality of sub-pipes may belong to the same pipe as each other, which may be referred to as a multi-pipe. In such cases, the multi-pipe may be the sole tenant of the given region of the storage unit, which may itself be statically or dynamically allocated to the multi-pipe. A directed graph may contain any number of divergent and convergent branches. A directed graph may contain any number of divergent and convergent branches.

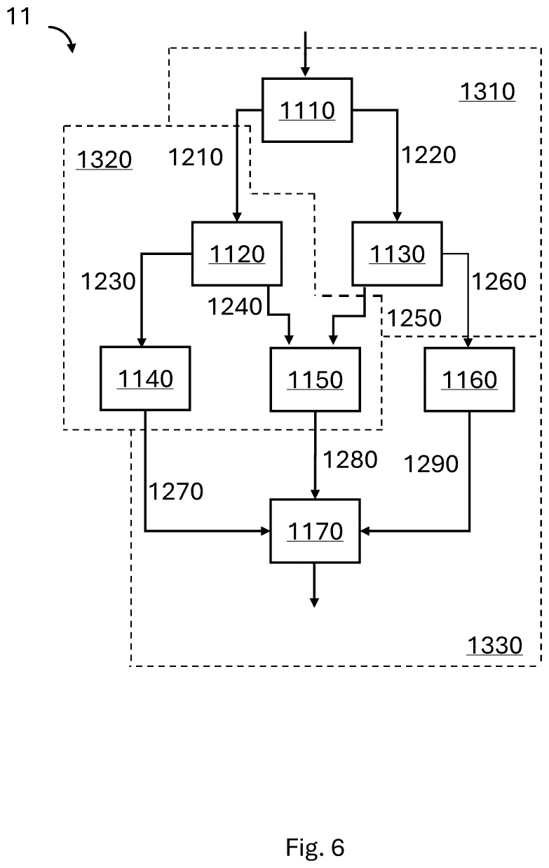

FIG. 6 illustrates an example directed graph 11 in which sections are interconnected by pipes or sub-pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe or sub-pipe. In FIG. 6, sections 2 and 3 (1120, 1130) each write to different respective sub-pipes (1230, 1240, 1250, 1260) of the same pipe, pipe 3, which is a multi-pipe. Each sub-pipe has its own unique identifier, which also indicates the multi-pipe to which the sub-pipe belongs, where a multi-pipe is a pipe comprising at least one sub-pipe, as explained above. In this case, section 2 writes to sub-pipes 3.0 and 3.1 (1230, 1240) and section 3 writes to sub-pipes 3.2 and 3.3 (1250, 1260), where the numeral prior to the period indicates the identifier of the multi-pipe (3) and the numeral after the period indicates the identifier of the sub-pipe of the multi-pipe (0 to 3 in this case). A region of a storage unit is allocated to multi-pipe 3, and respective storage elements of the region of the storge unit are dynamically allocated to sub-pipes 3.0 to 3.3. In this example, different sections (sections 2 and 3) thus write to the same underlying physical region of the storage unit, via dynamically allocated sub-pipes.

The directed graph 11 of FIG. 6 also includes sections 4 to 6 (1140 to 1170) and pipes 4 to 6 (1270 to 1290). The sections 4 and 6 (1140, 1160) receive input data from sub-pipes 3.0 and 3.3 (1230, 1260) respectively, and write data to pipes 4 and 6 (1270, 1290) respectively. Section 5 (1150) in FIG. 6 receives a first set of input data via sub-pipe 3.1 (1240) from section 2 (1120) and a second set of input data via sub-pipe 3.2 (1250) from section 3 (1130) and writes data to pipe 5 (1280). Section 7 (1170) of the directed graph 11 receives input data from pipes 4 to 6 (1270 to 1290). Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 6 illustrates an arrangement where the graph 11 is broken down into three sub-graphs 1310, 1320, and 1330 which can be connected together to form the complete graph. For example, sub-graph 1310 contains sections 1 and 3 (1110 and 1130) as well as pipe 2 and sub-pipe 3.3 (1220 and 1260)), sub-graph 1320 contains section 2, 4 and 5 (1120, 1140, and 1150) as well as pipe 1 and sub-pipes 3.0 to 3.2 (1210, 1230, 1240, and 1250), and sub-graph 1330 contains sections 6 and 7 (1160 and 1170) as well as pipes 4 to 6 (1270, 1280, and 1290).

### Hardware Implementation

Described below is an example hardware arrangement for executing linked operations for at least a portion of a directed graph as illustrated in FIG. 6.

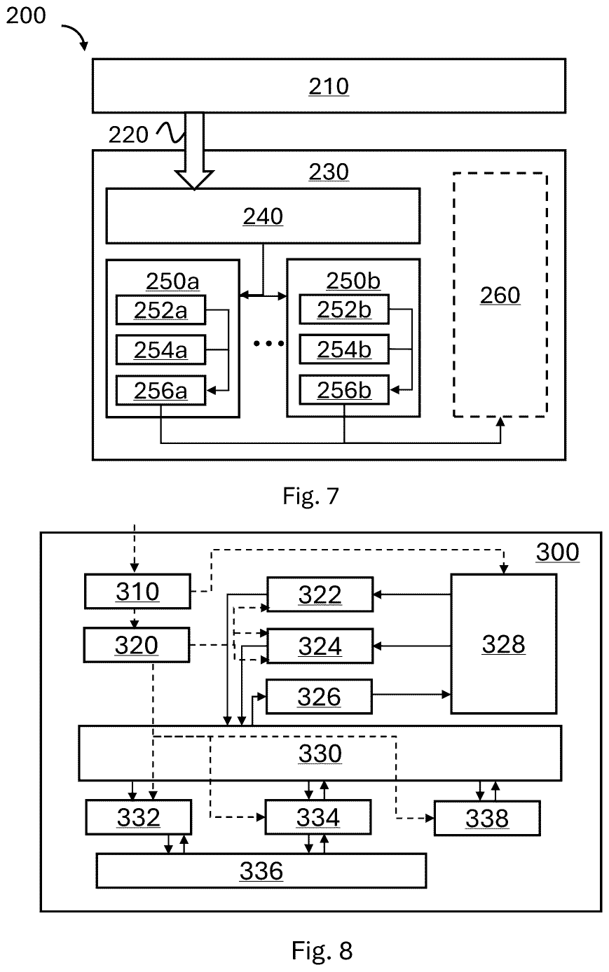

FIG. 7 shows schematically an example of a data processing system 200 including a processor 230 which may act as a co-processor or hardware accelerator unit for a host processing unit 210 (such as the CPU 4 of the apparatus 1 of FIG. 1). For example, the processor 230 (or at least one component thereof) may be used as the hardware accelerator 22 of FIG. 1. It will be appreciated that the types of hardware accelerator which the processor 230 may provide dedicated circuitry for is not limited to that of Neural Processing Units (NPUs) or Graphics Processing Units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable to utilize some of the GPU's existing resources (e.g. such that at least some functional units and resources of the GPU can effectively be shared between the different hardware accelerator circuitry, for instance), whilst still allowing an improved (more optimized) performance compared to performing all the processing with general purpose execution.

As such, the processor 230 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor means that the machine learning processing circuit may then be operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 7, the processor 230 is arranged to receive task data 220 from a host processor 210, such as a central processing unit (CPU). The task data comprises at least one command in a given sequence, each command to be executed, and each command may be decomposed into a number of tasks, such as tasks discussed in this disclosure. These tasks may be self-contained operations, such as a given machine learning operation. It will be appreciated that there may be other types of tasks depending on the command. For example, the task data 220 may comprise an instruction and/or a resource instruction to configure the processor 230 to perform the task. The instruction and/or the resource instruction may be sent from the host processor 210 (e.g. from accelerator control interface circuitry) to control interface circuitry of the processor 230 as a set of command messages and/or a resource message, e.g. as described with reference to the method 100 of FIG. 2 and the method 114 of FIG. 4, respectively.

The task data 220 is sent by the host processor 210 and is received by a command processing unit 240 which is arranged to schedule the commands within the task data 220 in accordance with their sequence. The task data 220 may be received by the control interface circuity of the processor 230 and then sent to the command processing unit 240, or the command processing unit 240 may comprise the control interface circuitry for receiving messages from the host processor 210. The command processing unit 240 is arranged to schedule the commands and decompose each command in the task data 220 into at least one task. For example, the command processing unit 240 may comprise accelerator processing circuitry configured to reconstruct the instruction from the set of command messages, e.g. as described with reference to the method 106 of FIG. 3, and/or to reconstruct the resource instruction from the resource message, e.g. as described with reference to the method 120 of FIG. 5. Alternatively, the accelerator processing circuitry for reconstructing the instruction and/or the resource instruction may reconstruct the instruction and/or the resource instruction separately, and send the reconstructed instruction and/or the reconstructed resource instruction to the command processing unit 240).

Once the command processing unit 240 has scheduled the commands in the task data 220, and generated a plurality of tasks for the commands, the command processing unit 240 issues each of the plurality of tasks to at least one compute unit 250a, 250b each of which are configured to process at least one of the plurality of tasks.

The processor 230 comprises a plurality of compute units 250a, 250b. Each compute unit 250a, 250b, may be a shader core of a GPU specifically configured to undertake a number of different types of operations, however it will be appreciated that other types of specifically configured processor may be used, such as a general-purpose processor configured with individual compute units, such as compute units 250a, 250b. Each compute unit 250a, 250b comprises a number of components, and at least a first processing module 252a, 252b for executing tasks of a first task type, and a second processing module 254a, 254b for executing tasks of a second task type, different from the first task type. In some examples, the first processing module 252a, 252b may be a processing module for processing neural processing operations, such as those which would normally be undertaken by a separate NPU. In these cases, the first processing module 252a, 252b is for example a neural engine. Similarly, the second processing module 254a, 254b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 240 issues tasks of a first task type to the first processing module 252a, 252b of a given compute unit 250a, 250b, and tasks of a second task type to the second processing module 254a, 354b of a given compute unit 250a, 250b. The command processing unit 240 would issue machine learning/neural processing tasks to the first processing module 252a, 252b of a given compute unit 250a, 250b where the first processing module 252a, 252b is optimized to process neural network processing tasks, for example by comprising an efficient means of handling a large number of multiply-accumulate operations. Similarly, the command processing unit 240 would issue graphics processing tasks to the second processing module 254a, 254b of a given compute unit 250a, 250b where the second processing module 252a, 254a is optimized to process such graphics processing tasks. In some examples, the first and second tasks may both be neural processing tasks issued to a first processing module 252a, 252b, which is a neural engine. Such a neural processing task may involve the processing of a tensor, e.g. representing a feature map, with weights associated with a layer of a neural network.

In addition to comprising a first processing module 252a, 252b and a second processing module 254a, 254b, each compute unit 250a, 250b also comprises a memory in the form of a local cache 256a, 256b for use by the respective processing module 252a, 252b, 254a, 254b during the processing of tasks. Examples of such a local cache 256a, 256b is a L1 cache. The local cache 256a, 256b may, for example, a synchronous dynamic random-access memory (SDRAM). For example, the local cache 256a, 256b may comprise a double data rate synchronous dynamic random-access memory (DDR-SDRAM). It will be appreciated that the local cache 256a, 256b may comprise other types of memory.

The local cache 256a, 256b is used for storing data relating to the tasks which are being processed on a given compute unit 250a, 250b by the first processing module 252a, 252b and second processing module 254a, 254b. It may also be accessed by other processing modules (not shown) forming part of the compute unit 250a, 250b the local cache 256a, 256b is associated with. However, in some examples, it may be necessary to provide access to data associated with a given task executing on a processing module of a given compute unit 250a, 250b to a task being executed on a processing module of another compute unit (not shown) of the processor 230. In such examples, the processor 230 may also comprise storage 260, for example a cache, such as an L2 cache, for providing access to data for the processing of tasks being executed on different compute units 250a, 250b.

By providing a local cache 256a, 256b tasks which have been issued to the same compute unit 250a, 250b may access data stored in the local cache 256a, 256b, regardless of whether they form part of the same command in the task data 220. The command processing unit 240 is responsible for allocating tasks of commands to given compute units 250a, 250b such that they can most efficiently use the available resources, such as the local cache 256a, 252b, thus reducing the number of read/write transactions required to memory external to the compute units 250a, 250b, such as the storage 260 (L2 cache) or higher-level memories. One such example, is that a task of one command issued to a first processing module 252a of a given compute unit 250a, may store its output in the local cache 252a such that it is accessible by a second task of a different (or the same) command issued to a given processing module 252a, 254a of the same compute unit 250a.

One or more of the command processing unit 240, the compute units 250a, 250b, and the storage 260 may be interconnected using a bus. This allows data to be transferred between the various components. The bus may be or include any suitable interface or bus. For example, an ARM® Advanced Microcontroller Bus Architecture (AMBA®) interface, such as the Advanced eXtensible Interface (AXI), may be used.

FIG. 8 shows schematically a neural engine 300, which in this example is used as a first processing module 252a, 252b in a data processing system 200 in accordance with FIG. 7. The neural engine 300 includes a command and control module 310. The command and control module 310 receives tasks from the command processing unit 240 (shown in FIG. 7), and also acts as an interface to storage external to the neural engine 300 (such as a local cache 256a, 256b and/or a L2 cache 260) which is arranged to store data to be processed by the neural engine 300 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 300 to perform particular processing (such as the reconstructed instruction and/or the reconstructed resource instruction to configure the neural engine 300 to perform a particular task) and/or data to be used by the neural engine 300 to implement the processing such as neural network weights.

The command and control module 310 interfaces to a handling unit 320, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 320 splits data representing a stripe of a feature map into a plurality of blocks of data, each of which represents a respective part of the feature map. The handling unit 320 also obtains, from storage external to the neural engine 300 such as the L2 cache 260, task data defining operations selected from an operation set comprising a plurality of operations. The task data may comprise or be in the form of a reconstructed instruction, reconstructed by the processor 230 or a component thereof. In this example, the operations are structured as a progression of operations representing a sequence of layers of the neural network. A block of data is allocated as an input to one of the operations by the handling unit 320.

The handling unit 320 coordinates the interaction of internal components of the neural engine 300, which include a weight fetch unit 322, an input reader 324, an output writer 322, a direct memory access (DMA) unit 328, a dot product unit (DPU) array 332, a vector engine 334, a transform unit 338, an accumulator buffer 332, and a shared storage 330, for processing of blocks of data. The data dependencies across the functional units are tracked by the handling unit 320. Processing is initiated by the handling unit 320 in a functional unit if all input blocks are available and space is available in the shared storage 330 of the neural engine 300. The shared storage 330 may be considered to be a shared buffer, in that various functional units of the neural engine 300 share access to the shared storage 330.

In the context of a directed graph representing the operations to be performed, each of the internal components that operates upon data can be considered to be one of two types of component. The first type of component is an execution unit (and is identified within the neural engine 300 as such) that maps to a section that performs a specific instance of an operation within the directed graph. For example, the weight fetch unit 322, input reader 324, output writer 322, dot product unit array 332, vector engine 334, transform unit 338 each are configured to perform one or more pre-determined and fixed operations upon data that it receives. Each of these sections can be uniquely identified with an identifier and each execution unit can also be uniquely identified.

Similarly, all physical storage elements within the neural engine 300 (and in some instances portions of those physical storage elements) can be considered to be uniquely identified within the neural engine 300. The handling unit 320 is configured to allocate storage elements to respective connections in the directed graph, which can correspond to pipes as explained above. For example, portions of the accumulator buffer 332 and/or portions of the shared storage 330 can each be regarded as a storage element that can act to store data for a pipe or a sub-pipe within the directed graph, as allocated by the handling unit 320. A pipe or a sub-pipe can act as a connection between sections (as executed by execution units) to enable a sequence of operations as defined in the directed graph to be linked together within the neural engine 300. Put another way, the logical dataflow of the directed graph can be mapped to the physical arrangement of execution units and storage elements within the neural engine 300. Under the control of the handling unit 320, execution can be scheduled on the execution units and data can be passed between the execution units via the storage elements in accordance with the mapping, such that the linked operations of a graph can be executed without needing to write data memory external to the neural engine 300 between executions. The handling unit 320 is configured to control and dispatch work representing performing an operation of the graph on at least a portion of the data provided by a pipe or a sub-pipe.

The weight fetch unit 322 fetches weights associated with the neural network from external storage and stores the weights in the shared storage 330. The input reader 324 reads data to be processed by the neural engine 300 from external storage, such as a block of data representing part of a tensor. The output writer 322 writes data obtained after processing by the neural engine 300 to external storage. The weight fetch unit 322, input reader 324 and output writer 322 interface with the external storage (which is for example the level one cache 10) via the DMA unit 328.

Data is processed by the DPU array 332, vector engine 334 and transform unit 338 to generate output data corresponding to an operation in the directed graph. The result of each operation is stored in a specific pipe or sub-pipe within the neural engine 300. The DPU array 332 is arranged to perform one or more operations associated with a dot product operation between two operands, such as between an array of weights and a corresponding block of data (e.g. representing part of a tensor). The vector engine 334 is arranged to perform elementwise operations, for example to apply scale parameters to scale an output of a dot product calculated by the DPU array 332. Data generated during the course of the processing performed by the DPU array 332 and the vector engine 334 may be transmitted for temporary storage in the accumulator buffer 332 from where it may be retrieved by either the DPU array 332 or the vector engine 334 (or another different execution unit) for further processing as desired.

The transform unit 338 is arranged to perform in-block transforms such as dimension broadcasts or axis swaps. The transform unit 338 obtains data (e.g. after processing by the DPU array 332 and/or vector engine 334) from a pipe or a sub-pipe, for example mapped to at least a portion of the shared storage 330 by the handling unit 320. The transform unit 338 writes transformed data back to the shared storage 330.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements and/or between sub-pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes and/or sub-pipes.

All storage in the neural engine 300 may be mapped to corresponding pipes and/or sub-pipes, including look-up tables, accumulators, etc. The width and height of pipes and/or sub-pipes can be programmable, resulting a highly configurable mapping between pipes, sub-pipes and storage elements within the neural engine 300.

Ordering of execution of the sections is implied by dependencies on inputs. A memory load operation has no data dependencies (unless it is a gather operation), so is implicitly early in the graph. The consumer of the pipe (or sub-pipe) that the memory read produces is implicitly after the memory read. A memory store operation is near the end of the graph, as it produces no pipes or sub-pipes for other operations to consume. The sequence of execution of a progression of operations is therefore handled by the handling unit 320.

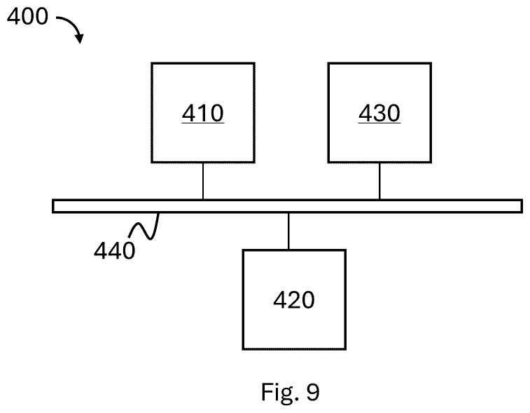

FIG. 9 shows schematically a system 400 for allocating handling data, and in some examples generating a plurality of blocks of input data for processing.

The system 400 comprises host processor 410 such as a central processing unit, or any other type of general processing unit. The system 400 also comprises a processor 430, which may be similar to or the same as the processor 230 of FIG. 7. The system 400 may also include at least one further processor (not shown), which may be the same as the processor 430. The processor 430, and the host processor 410 may be combined as a System on Chip (SoC) or onto multiple SoCs to form one or more application processors.

The host processor 410 issues task data comprising a plurality of commands, each having a plurality of tasks associated therewith. The task data may be issued in the form of a set of command messages provided by the host processor 410 to the processor 430, and may be based on (and may, for example, represent) an instruction for configuring the processor 430 to perform a particular task.

The system 400 also comprises memory 420 for storing data generated by the tasks externally from the processor 430, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 250a, 250b of a processor 430 so as to maximize the usage of the local cache 252a, 252b.

In some examples, the system 400 may comprise a memory controller (not shown), which may be a dynamic memory controller (DMC). The memory controller is coupled to the memory 420. The memory controller is configured to manage the flow of data going to and from the memory. The memory may comprise a main memory, otherwise referred to as a ‘primary memory’. The memory may be an external memory, in that the memory is external to the system 400. For example, the memory 420 may comprise ‘off-chip’ memory. The memory may have a greater storage capacity than local caches of the processor 430 and/or the host processor 410. In some examples, the memory 420 is comprised in the system 400. For example, the memory 420 may comprise ‘on-chip’ memory. The memory 420 may, for example, comprise a magnetic or optical disk and disk drive or a solid-state drive (SSD). In some examples, the memory 420 comprises a synchronous dynamic random-access memory (SDRAM). For example, the memory 420 may comprise a double data rate synchronous dynamic random-access memory (DDR-SDRAM).

One or more of the host processor 410, the processor 430, and the memory 420 may be interconnected using a system bus 440. This allows data to be transferred between the various components. The system bus 440 may be or include any suitable interface or bus. For example, an ARM® Advanced Microcontroller Bus Architecture (AMBA®) interface, such as the Advanced eXtensible Interface (AXI), may be used.

### Example Data Structures

In an example, a task issued by the command processing unit 240 for execution by the neural engine 300 is described by task data, which in this example comprises a neural engine program descriptor (NED), which is a data structure stored in memory and retrieved by the neural engine when executing the task issued by the command processing unit. The NED describes at least a portion of a complete graph of operations (sections) to be performed when executing the graph of operations (e.g. representing a neural network). As discussed above, sections are mapped to various hardware execution units within the neural engine 300 and essentially represent instantiations of a particular operator at a position within the graph. In one example, these sections are described by specific ‘elements’ that collectively define the operations forming part of the NED. Furthermore, the NED has an unordered list of pipes and/or sub-pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes and/or sub-pipes.

In an example, a neural engine task describes a 4D bounding box (dimensions #0-3) that should be operated on by the section operations of a graph defined by the NED. As well as describing the graph, the NED also defines a further four dimensions (dimensions #4-7), making for a total 8-dimension operation-space. The bounding box for the first four dimensions is a sub-region of the full size of these dimensions, with different tasks and/or jobs covering other sub-regions of these dimensions. As illustrated in FIGS. 7 and 8, the command processing unit 240 may issue different tasks to different neural engines. As such, the dimensions 0-3 are defined when the NED is generated or at the point that the task is defined. The latter four dimensions are described in their entirety in the NED and are therefore covered entirely in each task. The NED additionally defines an increment size for each of these 8 dimensions to be stepped through, known as a block size. Execution of the graph against this 8D operation-space can be considered as a series of nested loops. A task may thus be considered to define a multi-dimensional bounding box.

FIG. 10 shows an example of a data structure 500 for storing an instruction for configuring the processor 230 (e.g. the neural engine 300 of the processor 230) to perform a neural engine task such as this, which comprises execution of a multi-dimensional nested loop over a plurality of dimensions. The data structure 500 may be sent to the processor 230 as a payload, which may be split over a set of command messages (e.g. a plurality of CREQ packets). Each CREQ packet starts with a separate packet header (which indicates a size of the payload included in that packet, among other things) but includes a different respective portion of the payload (i.e. a different respective portion of the data structure 500). In FIG. 10, the task comprises processing of a portion of a multi-dimensional tensor, for example representing a portion of a feature map. In FIG. 10, the task comprises a loop over 4 dimensions (labelled 0, 1, 2, 3). The instruction defines a coordinate range within a multi-dimensional space corresponding to the portion of the multi-dimensional tensor that is to be processed. FIG. 10 is simplified with respect to an 8D neural engine task, and instead corresponds to processing in 4 dimensions. However, it is to be appreciated that the actual dimensionality of the task may be higher than 4, and in some cases higher than 8 (e.g. 12). The predefined set of fields of the instruction comprise, for each respective dimension of a plurality of dimensions (in this case, for each of the 4 dimensions), lower and upper bound fields indicative of a lower and upper bounds of the coordinate range in the respective dimension.

In this example, the data structure 500 is separated into 8 B words, divided into two rows of 4 B each in FIG. 10. The data structure 500 comprises the following predefined set of fields:
a “params” field (bits [31:0] of row 0 and bits [7:0] of row 1);
a header field (bits [31:28] of row 1, which take predefined values of 0001 respectively);
a first “Reserved” field (bits [27:8] of row 1);
a “ned_pointer” field (bits [31:0] of rows 2 and 3);
a “trace_id” field (bits [31:8] of row 4 and bits [31:0] of row 5);
a “task_id” field (bits [7:0] of row 4);
an “nestat_pointer” field (bits [31:0] of rows 6 and 7);
a “task_seed” field (bits [31:0] of rows 8 and 9);
a second “Reserved” field (bits [31:0] of rows 10 to 15);
a “task_lower_bound_dimn” field for dimensions n=0, 1, 2, 3 (bits [31:0] of rows 16-17, 20-21, 24-25, 28-29 respectively);
a “task_upper_bound_dimn” field for dimensions n=0, 1, 2, 3 (bits [31:0] of rows 18-19, 22-23, 26-27, 30-31 respectively); and
“task_const_m” fields for constants m=0, 1, 2, 3 (bits [31:0] of rows 32-33, 34-35, 36-37, 38-39, respectively).

The “params” field corresponds to a control field indicative of a selected set of fields of the predefined set of fields to be provided to a hardware accelerator 22 to perform the task. The “params” field itself is included in the selected set of fields so as that the control field is provided to the hardware accelerator 22 to enable the hardware accelerator 22 to correctly reconstruct the instruction. The control field may take various forms. In the example of FIG. 10, the control field comprises a mask indicative of whether each 8 B word is included in the selected set, on a per-word basis. In other examples, though, the control field comprises a mask indicative whether each field is included the predefined set of fields is included in the selected set, on a per-field basis. Indicating whether each element is to be included in the selected set on a per-element (e.g. per-word or per-field) basis for example provides flexibility in the selection of data for the selected set, which may improve efficiency by reducing the sending of unnecessary data to a greater extent than less flexible approaches. A mask may be a compact and efficient way of signaling which of the fields are to be included in the selected set.

In this example, the mask is a bit-wise mask, comprising an element per word. As there are 20 words in the example of FIG. 10, the mask comprises 20 elements, each corresponding to a different respective word. In this case, the “params” field has a bit-length of 40 bits, so is capable of storing values of up to 40 elements but in other cases the bit-length of the “params” field may be equal to the number of fields in the predefined set of fields. A state of each of the elements can indicate, in a simple manner, whether the corresponding portion of the predefined set of fields (e.g. a corresponding word, set of words or field(s)) is to be included in the selected set. For example, if an element of the mask has a value of 0, this may indicate (and in FIG. 10 does indicate) that the corresponding word (and the field(s) stored in that word) is excluded from the selected set of fields and is thus to be omitted in a set of command messages to send to the hardware accelerator. Conversely, a non-zero value of an element of the mask, such as a value of 1, may indicate (and in FIG. 10 does indicate) that the corresponding word (and the field(s) stored in that word) is included in the selected set of fields and is thus to be provided to the hardware accelerator, via the set of command messages.

The predefined value of the header is used to indicate to the hardware accelerator 22 that this is the start of the instruction, and is thus typically included in the selected set of fields. The “Reserved” fields may be set aside for desired use as defined by the processing circuitry 6 and are typically not included in the selected set of fields. The “ned_pointer” field is an example of a task field indicative of a task descriptor defining at least one operation for performing the task. In this case, the “ned_pointer” field provides a pointer to the NED for the task, indicating a physical address of the NED in storage, such as storage of or accessible to the CPU 4 and/or the hardware accelerator 22. The “ned_pointer” field is typically included in the selected set of fields, so as to configure the hardware accelerator 22 to perform the task defined by the NED. The “trace_id”, “task_id” and “nestat_pointer” for example provide information for use by processing circuitry (such as that of the CPU 4 and/or the hardware accelerator 22) in keeping track of the processing performed, which may be used to aid in detecting and resolving processing errors or issues. At least one of the “trace_id”, “task_id” and “nestat_pointer” fields may be included in the selected set of fields in a development environment (for example for debug purposes) and skipped (e.g. not included in the selected set of fields) in a deployed environment in which the data structure 500 is deployed to perform the task. The “task_seed” field represents a seed value that can be used in randomized operations to perform the task, such as randomized or stochastic rounding. The seed value is typically non-zero, so the “task_seed” field will typically be included in the selected set of fields if random numbers are used in performing the task. However, the “task_seed” field may be omitted in some cases, such as for the performance of some tasks that do not involve the use of random numbers.

The “task_lower_bound_dimn” and “task_upper_bound_dimn” fields for a given dimension represent the lower and upper bounds of the coordinate range in that dimension. The “task_const_m” fields represent constant values (labelled using arbitrary labels m=0, 1, 2, 3) used in processing for various arbitrary reasons. For example, a constant value represented by a “task_const_m” field can be used as a padding value, so that when an out-of-bounds region of a tensor is accessed, the out-of-bound coordinates are filled with the constant value. A constant value can be used in standard vector operations, e.g. to subtract, multiply etc. a tensor with a constant value. A constant value can be used in the calculation of a dimension, e.g. to provide some striding or offsetting in a dimension while calculating dimensions of blocks within that dimension. It is to be appreciated that these uses of constant values are non-limiting, and constant values may be used for various purposes.

It may be expected or anticipated that the certain fields will be utilized by the hardware accelerator 22 in executing the task, irrespective of the task itself. For example, typically the control field will be used by the hardware accelerator 22 to determine which of the fields of the predefined set of fields are received in the set of command messages. The task field, indicative of the task descriptor, will also typically be used by the hardware accelerator 22 to determine which task is to be performed. A header field, for example indicative of a start of an instruction to configure the hardware accelerator 22 may also be used by the hardware accelerator 22 to identify when a new instruction is received. The processing circuitry 6 may thus be configured to generate the instruction to indicate that a predefined selected set of fields (e.g. the control field, the header field and/or the task field) is comprised by the selected set of fields. The predefined selected set of fields are, for example, those fields that are typically sent to the hardware accelerator 22 independently of the nature of the task itself. By predefining these fields, the determination of which of the fields to include in the selected set of fields may be simplified.

The greater the number of fields that can be omitted from the selected set of fields to be sent to the hardware accelerator 22, via the set of command messages, the smaller the combined size of the set of command messages. Typically, at least some of the predefined set of fields can be omitted from the selected set of fields. For example, at least some of the predefined set of fields may tend to be zero (or another predefined, null or otherwise default value) for particular tasks, and may be excluded from the selected set of fields.

In some cases, a value of at least one of the predefined set of fields may be set to a predefined value, such as zero, in order to further reduce the number of fields included in the selected set of fields. In such cases, the setting of the value(s) to the predefined value may be compensated for elsewhere within a pipeline for performing the task, for example by adjusting another value to be sent to, or to be used by, the hardware accelerator 22.

In the example of FIG. 10, a lower bound of the coordinate range corresponding to the portion of the multi-dimensional tensor may be reset to a predefined value (e.g. zero) in at least one dimension of the multi-dimensional space to generate at least one adjusted lower bound. In this case, the predefined set of fields comprises at least one lower bound field indicative of a respective adjusted lower bound. By resetting the lower bound to the predefined value for a particular dimension, the lower bound field indicative of the adjusted lower bound can be omitted from the selected set of fields, so as to reduce the amount of data sent to the hardware accelerator 22. This is signaled to the hardware accelerator 22 by the control field indicating that the field corresponding to the adjusted lower bound for that particular dimension is not included in the selected set of fields (and thus has a predefined value, which may be zero). The hardware accelerator 22 can then determine, based on the control field for that field, that the value of that field is the predefined value, e.g. zero.

In this example, the processing circuitry 6 may be configured to adjust a tensor descriptor defining the portion of the multi-dimensional tensor to compensate for resetting the lower bound of the coordinate range to the predefined value in the at least one dimension. For example, the processing circuitry 6 may adjust the coordinate range to artificially set the lower bounds for each of at least one dimension to zero and then modify the tensor descriptor (e.g. representing a tensor base pointer for the portion of the tensor, as described above) to compensate for this adjustment. The tensor descriptor in the example of FIG. 10 is stored in a table of tensor descriptors. A physical storage address associated with the table is included in a resource instruction, such as that stored in the further data structure 600 of FIG. 11, which is executed by the hardware accelerator 22 in order to obtain the tensor descriptor (and thus the tensor itself) when the task is performed.

Without the resetting of the lower bound to the predefined value (e.g. zero) in this manner, the lower bound will typically be a non-zero (e.g. non-predefined value), which will differ for each different portion of the tensor to be processed. As different tasks may correspond to processing of different tensor portions, this means that the lower bound would generally differ for each task (and may differ for each of a plurality of dimensions) and would thus need to be included in the selected set of fields for each task. Hence, resetting the lower bound to the predefined value in each of at least one dimension can result in a notable reduction in the amount of data to be sent to the hardware accelerator 22.

To reduce the amount of data transferred from the apparatus 1 to the hardware accelerator 22, the processing circuitry 6 may also or instead reset a lower bound and an upper bound of a given dimension of a multi-dimensional bounding box defined by the task (e.g. comprising the portion of the tensor) to a predefined value, e.g. zero, to indicate that the given dimension is unused in performing the task, thereby generating an adjusted bounding box. In these cases, the predefined set of fields comprises a set of fields indicative of the adjusted bounding box. This for example allows unused dimension(s) to be signaled more efficiently than other approaches. In a comparative example, an offset field is set to a predefined value of 0 and a size field is set to a (non-predefined) value of 1 for a particular dimension to indicate that the particular dimension is unused, meaning that the offset field can be omitted from the selected set of fields by the size field is included in the selected set of fields. However, if both the lower and upper bound fields for a particular dimension comprise reset lower and upper bound values set to a predefined value of 0 to indicate that the particular dimension is unused, both of these fields may be omitted from the selected set of fields, decreasing the number of fields to be sent to the hardware accelerator 22 to signal that the particular dimension is unused, relative to the comparative example.

An example of an instruction stored in the data structure 500 of FIG. 10 will now be described. In this example, the first word is included in the selected set, so as to include the “params” field (and the header and first “Reserved” fields also stored in the first word). The second and third words are also included, so as to include the “ned_pointer”, “trace_id” and “task_id” fields in the selected set. The fourth word is not included, so as to omit the “nestat_pointer” field, but the fifth word is included, so as to include the “task_seed” field in the selected set. The sixth to eighth words, corresponding to the second “Reserved” field, are omitted from the selected set. This means that the control field for the first eight words takes a value of 11101000 (with the leftmost bit indicating whether the first word is included and the rightmost bit indicating whether the eighth word is included, with a value of 1 indicating that a word is included and a value of 0 indicating that a word is omitted from the selected set).

Whether the remainder of the words are included will typically depend on the task itself, and the number of dimensions of the task. This may be determined by the processing circuitry 6, for example by analyzing a directed graph indicative of the task. In the example of a simple matrix multiplier, the lower bounds may be reset to 0 for the first 3 dimensions and the upper bounds for those 3 dimensions will correspond to a value representative of the task at hand. The remaining dimension (the fourth dimension) is unused. This means that the control field for the remaining twelve fields takes a value of 010101001110 (with the leftmost bit indicating whether the ninth word is included and the rightmost bit indicating whether the twentieth word is included), i.e. so that the control field as a whole takes a value of 11101000010101001110 (with the leftmost bit indicating whether the first word is included and the rightmost bit indicating whether the twentieth word is included). There are therefore 10 words of data to send to the hardware accelerator 22 to send the selected set of fields, rather than the 20 words corresponding to the predefined set of fields.

The processing circuitry 6 includes the selected words in a set of command messages so as to send the selected set of fields to the hardware accelerator 22, via the accelerator control interface circuitry 14. Words that are not to be included, based on the control field, are skipped. For example, the fourth, sixth, eighth (and so on) words are skipped from those included in the set of command messages. The set of command messages may be sent to the hardware accelerator 22 one at a time, but without necessarily waiting for a response from the hardware accelerator 22 before sending a subsequent command message.

In this example, the processing circuitry 6 and the hardware accelerator 22 are configured to exchange messages of up to 64 B in size. In this case, a first command message of the set of command messages is 64 B in size and is formed of the first eight selected words of the data structure 500. Upon receiving the first command message, the hardware accelerator 22 obtains the header field of 0001, which indicates that the first command message is a first message of a set of command messages. The hardware accelerator 22 also obtains the “params” field (corresponding to the control field), which is used by the hardware accelerator 22 to decode the remaining words of the first command message. Based on the “params” field indicating that the next two words are each associated with values of 1, the hardware accelerator 22 associates the next two words received via the set of command messages (which may e.g. be within the first command message) as storing the “ned_pointer”, “trace_id” and “task_id” fields, as these are the predefined fields associated with the second and third words. The “params” field indicates that the next word (word four) is associated with a value of 0, indicating that this word has been skipped from the set of command message and that the predefined field associated with this word is not included in the selected set of fields. Based on this, the hardware accelerator 22 determines that the fourth word, corresponding to the “nestat_poiner” predefined field, has been omitted from the set of command messages.

This process continues at the hardware accelerator 22, until all of the selected words of the first command message have been identified, based on the control field, and the unselected words have been set to a predefined value (which is 0 in this case). The hardware accelerator 22 then receives subsequent message(s) of the set of command messages until the selected set of fields has been received, and the instruction has been reconstructed. In this case, there are two command messages, so as to send ten 8 B words in total. The first command message is formed of the first, second, third, fifth, tenth, twelfth, fourteenth and sixteenth words of the data structure 500 and the second command message is formed of the eighteenth and twentieth words of the data structure 500 (with the other words of the data structure 500 omitted). In other cases, though, the ten words of this example may be distributed differently between the first and second command messages. The words to be sent to the hardware accelerator 22 as the first command message may be written to the DATA registers of CLAC registers 23 before they are sent to the hardware accelerator 22. Once they have been sent to the hardware accelerator 22, they may be overwritten in the DATA registers by the subsequent word(s) to be sent to the hardware accelerator in subsequent command message(s) (in this case, by the eighteenth and twentieth words).

After receiving the first command message, the hardware accelerator 22 determines, based on the “params” field, that two words have not yet been received. The hardware accelerator 22 can then determine that the second command message is partway through a set of command messages (as the total number of selected fields indicated by the “params” field in the first command message has not yet been received). However, after receiving the second command message and based on a value of the sequence indicator field “seq” (e.g. as described with reference to FIG. 12) and/or determining that the second command message includes two words (the number of words remaining to be received, according to the “params” field), the hardware accelerator 22 identifies that the selected set of fields has been received and, in response, sends an acknowledgement to the CPU 4. The hardware accelerator 22 may determine whether a command message including the final words of the set of command messages (according to the “params” field) is also associated with a “seq” value of 1 (indicating that the message is the final message of a set of command messages). If not, this indicates that there is a mismatch, which may cause the hardware accelerator 22 to send an error message to the accelerator control interface circuitry 14.

If there is no mismatch, and the hardware accelerator 22 is idle, and able to accept the instruction represented by the set of command messages, the hardware accelerator 22 sends an OK response to the accelerator control interface circuitry 14. The hardware accelerator 22 then performs the task indicated by the instruction until it has completed the task, at which point it sends a message to the accelerator control interface circuitry 14 indicating that the task is complete.

FIG. 11 shows an example of a further data structure 600 for storing a resource instruction, which may be used in conjunction with the data structure 500 of FIG. 10 for configuring a hardware accelerator 22 to perform a task (such as a neural processing task). In the example of FIGS. 10 and 11, configuration instructions for configuring the hardware accelerator 22 to perform the task have been separated into the instruction (stored in the data structure 500 of FIG. 10) and the resource instruction (stored in the data structure 600 of FIG. 11).

In FIG. 11, the further data structure 600 is separated into 4 B words, each corresponding to respective rows in FIG. 11. Some pairs of adjacent rows are combined to form 8 B words in FIG. 11. The resource instruction stored in the further data structure 600 provides a pointer to a physical address in storage accessible to the hardware accelerator 22 of four resource tables (labelled from 0 to 3, and which are referred to interchangeably herein as “tables” for brevity) for storing resources for use in performing the task, such as tensor descriptors. The pointer for example indicates a resource table base address for each respective table. The resource instruction also indicates a size of each of the tables (such as a bit-length) so as to determine a physical area in the storage storing each respective table.

The further data structure 600 comprises the following predefined set of resource fields:
an “nrts” field (bits [3:0] of row 0);
a header field (bits [31:28] of row 1, which take predefined values of 0000 respectively);
a “Reserved” field (bits [31:4] of row 0 and bits [27:0] of row 1);
an “nrt_pointer_n_addr” field indicating the pointer to the physical address for each of resource tables n=0, 1, 2, 3 (bits [31:0] of rows 2-3, 4-5, 6-7, 8-9 respectively);
an “nrt_pointer_n_size” field indicating the size of each of the resource tables n=0, 1, 2, 3 (bits [31:0] of rows 10, 11, 12, 13 respectively);

The “nrts” field corresponds to a resource control field indicative of a selected set of resource fields of the predefined set of resource fields discussed above with reference to FIGS. 4 and 5. The selected set of resource fields for example indicates which of the resource fields are to be provided for the hardware accelerator 22 to perform the task. For example, the selected set of resource fields may include the “nrt_pointer_n_addr” and “nrt_pointer_n_size” fields for resource table(s) that have been updated (or for table(s) that are to be used for the first time by the hardware accelerator 22). For example, if table 0 has been updated (and is e.g. stored in a different physical storage location, with a different physical address) but the other tables have been used previously and have not been updated subsequently, the “nrts” field may indicate that the fields for table 0 (i.e. “nrt_pointer_0_addr” and “nrt_pointer_0_size”) are to be provided to the hardware accelerator 22.

In examples, the NED pointer comprised by the “ned_pointer” field of the predefined set of fields stored in the data structure 500 of FIG. 10 points to tensor descriptors by specifying a table number (e.g. corresponding to one of tables n=0, 1, 2, 3) and a table index (identifying an element of a table). The resource instruction of the predefined set of resource fields stored in the further data structure 600 of FIG. 11 allows a configuration for any combination of the tables to be changed at a given time. For example, table 0, or table 1 and 2, or table 0, 2 and 3, and so forth, can be changed using a given resource instruction. The resource instruction is typically the same between tasks, but in some cases at least one of the tables may be changed. For example, 3 of the tables may remain the same but one may be changed. A number of tables to be changed may be reduced by determining, using the processing circuitry 6, to store tensor descriptors that are expected to change in a given table and to store tensor descriptors that are expected to remain unchanged between tasks in the other three tables.

In order to change a given tensor descriptor (e.g. to reset lower bound(s) to zero, as discussed with reference to FIG. 10), the processing circuitry 6 may modify the tensor descriptor in place (e.g. as stored in a particular table). Alternatively, the processing circuitry 6 may duplicate the tensor descriptor at a new address in storage and use the resource instruction to update the table configuration so that the NED points to the updated tensor descriptor.

In a first example, a NED (e.g. with a physical storage address indicated by the “ned_pointer” field of the instruction) points to four tensors: A, B, C and D. In this example, the NED is to be executed twice with different offsets (in this case, adjusted lower bounds) in tensors B and C, but unchanged offsets (in this case, unchanged lower bounds) in tensors A and D. The processing circuitry 6 allocates a tensor descriptor for tensor A (tdA) to table 0, index 0, and a tensor descriptor for tensor D (tdD) to table 0, index 1. The processing circuitry 6 allocates a tensor descriptor for tensor B (tdB) to table 1, index 0, and a tensor descriptor for tensor C (tdC) to table 1, index 1. The processing circuitry 6 generates the resource instruction for table 0 and 1 and then the instruction. The resource message and the set of command messages based on the resource instruction and the instruction, respectively, are received by and run by the hardware accelerator 22 to cause the NED to be executed for the first time. Subsequently, the processing circuitry 6 modifies the tables of tdB and tdC in table 1 so that the second time the NED is executed by the hardware accelerator 22 the adjusted lower bounds are obtained (in this case, from the same addresses in storage as they were stored in the first time the NED is executed). However, in practice, tensor descriptors may be cached so on the second execution of the NED, it is not guaranteed that the updated tensor descriptors will be seen without an invalidation. If the two executions of the NED are to be run back-to-back, waiting to invalidate will typically lead to a delay.

In a second example which includes two executions of the NED of the first example, the processing circuitry 6 similarly allocates tdA to table 0, index 0, tdD to table 0, index 1, tdB to table 1, index 0 and tdC to table 1, index 1. The processing circuitry 6 generates the resource instruction for table 0 and 1 and then the instruction. The resource message and the set of command messages based on the resource instruction and the instruction, respectively, are received by and run by the hardware accelerator 22 to cause the NED to be executed for the first time. However, in this example, the processing circuitry 6 then duplicates table 1 to a new location in storage, with updated values for tdB and tdC (representing the adjusted lower bounds). The processing circuitry 6 then generates the resource instruction again, to indicate that table 1 has changed, and generates the instruction to instruct execution of the second NED. The resource message based on the resource instruction is received by the hardware accelerator 22 and run, but only for table 1 this time, so as to change the pointer to the new copy of table 1. The set of command messages based on the instruction are then received by and run by the hardware accelerator 22 to cause the NED to be executed for the second time. Execution of the NED for the second time still involves accessing table 1, index 0 and index 1 (for tensors B and C, respectively), but these point to new addresses so that the execution of the second instruction utilizes the new tensor descriptors B and C, that include the adjusted lower bounds.

In a third example, which is similar to the second example, there are more than 4 tensors and a pattern repeats itself. In the third example, if there are four variations of tensor descriptors that are to be rewritten, each tensor descriptor can be written at index N*4 (minus 1 for zero-indexing). So, the first tensor descriptor can be written at index 0, the second at 4, the third at 8 and so on. Then, the second variation can be written at (N*4)+1 (minus 1). so, the rewritten first tensor descriptor would be at index 1, the rewritten second tensor descriptor at 5, and so on. Then, the resource instruction may be used to change the table base address to offset by 0, 1, 2 or 3 (which may be indicated by a further field in the predefined set of fields of the resource instruction, in addition to or instead of at least one of the fields of the further data structure 600 of FIG. 11). An index might be 32 B, giving rise to an offset in the resource table base address of 0 B, 32 B, 64 B or 96 B. This would mean that the NED can reference index 0, 4, 8 and so on, but an offset indicated by the resource instruction of 1 (32 B) would cause it to access 1, 5, 8 and so on, and an offset of 2 would cause it to access 2, 6, 10 and so on.

Returning to the further data structure 600 of FIG. 11, it is to be appreciated that the resource control field may take various forms. For example, the resource control field may comprise a mask indicative of whether each field of the predefined set of resource fields is included in the selected set. The mask may indicate whether respective fields or words are included in the selected set on a per-field or per-word basis. Indicating whether each field or word is to be included in the selected set on a per-field or per-word basis for example provides flexibility in the selection of fields or words for the selected set, which may improve efficiency by reducing the sending of unnecessary data to a greater extent than less flexible approaches. A mask may be a compact and efficient way of signaling which of the fields are to be included in the selected set. The mask may be a bit-wise mask, comprising an element per field or per word. For example, a state of each element of the mask can indicate straightforwardly whether a given field or word is to be included in the selected set. A state of 0 may indicate that the field or word is omitted from the selected set and a non-zero state (such as a state of 1) may indicate that the field or word is included in the selected set.

In the example of FIG. 11, the mask is a bit-wise mask, comprising an element per resource (in this case, per resource table). As there are 4 resource tables, the mask in FIG. 11 comprises 4 elements (stored in bits [3:0] of the first row), each corresponding to a different respective resource table. A state of each of the elements can indicate whether field(s) associated with a particular resource table are to be included in the selected set of fields. For example, if an element of the mask has a value of 0, this may indicate that the field(s) for the resource table corresponding to that element are excluded from the selected set of fields and are thus to be omitted in a set of command messages to send to the hardware accelerator. Conversely, a non-zero value of an element of the mask, such as a value of 1, may indicate that the corresponding field(s) for that resource table are included in the selected set of fields and are thus to be provided to the hardware accelerator, via the set of command messages. This may require further logic to identify which fields are associated with which resource table, but may allow the size of the resource control field to be reduced compared to signaling on a per-field or per-word basis.

The predefined value of the header is used to indicate to the hardware accelerator 22 that this is the start of the resource instruction, and is thus typically included in the selected set of fields. The “Reserved” field may be set aside for desired use as defined by the processing circuitry 6 and is typically not included in the selected set of fields. The “nrt_pointer_n_addr” fields for tables n=0 to 3 comprises a pointer to the resource table base address for each of tables n=0 to 3. The “nrt_pointer_n_size” fields for tables n=0 to 3 indicates a bit-length for each of tables n=0 to 3.

FIG. 12 illustrates the communication of transactions 700 over the CREQ and CRSP control interface channels between the CPU 4 and the hardware accelerator 22 of FIG. 1. In one example the transactions (e.g. formed of the set of command messages) may be issued in response to execution of dedicated control instructions by the processing circuitry 6 of the CPU 4 (e.g. to generate the instruction and instruct the sending of the selected set of fields of the instruction using the set of command messages). However, in another example the transactions issued by the CPU 4 are issued in response to the processing circuitry 6 writing data identifying the transaction and a target hardware accelerator to the LAUNCH register.

As explained with reference to FIG. 1, the set of command messages sent from the apparatus 1 to the hardware accelerator 22 may comprise a command-without-response message (CMDNR) indicating that the hardware accelerator 22 does not need to acknowledge the command-without-response message, and a command-with-response message (CMD) indicating that the hardware accelerator 22 is to acknowledge the command-with-response message. FIG. 12 illustrates a set of command messages comprising a command-without-response message CMDNR, which is sent by the CPU 4 to launch the performance of a task by the hardware accelerator 22 (indicated as ACC in FIG. 12). The CMDNR message has a size of up to 64 B as each of the DATA registers of the CLAC registers 23 has a size of 64 B. In response to the CMDNR message the hardware accelerator 22 is not required to provide any response, and in some cases the hardware accelerator 22 is not allowed to provide any response. Using the CMDNR message the CPU 4 can launch multiple consecutive messages without waiting for responses from the hardware accelerator 22 in between. This allows for a higher rate at which messages can be sent to the hardware accelerator 22. In FIG. 12, a set of messages may include up to 7 CMDNR messages and 1 CMD message, so that 64 B may be streamed from each of the eight DATA registers to the hardware accelerator 22 before a response is requested from the hardware accelerator 22.

A first message in a set of command messages may be indicated by setting bit 7 in the LAUNCH register to 0 (i.e. to set seq=0, indicating that the first message is the first of a sequence, e.g. set, of command messages). Subsequent CMDNR messages of the set of command messages may be issued with seq=1. The set of command messages is be terminated by a CMD message with seq=1, to which a response is expected. The hardware accelerator 22 may also or instead determine that a given message comprises the final field of the selected set of fields for a given instruction based on the control field for that set of command messages (e.g. after a particular number of fields have been received, corresponding to a number of fields in the selected set of fields as indicated by the control field). In an example, an error message is generated if the final field of the selected set of fields is not comprised by a CMD message, with seq=1. The hardware accelerator 22 responds to the final CMD message with an OK transaction (without payload), an ERROR transaction, or a BUSY transaction. The OK transaction indicates that the task identified by the set of messages has been successfully started. The BUSY transaction indicates that the hardware accelerator 22 is busy, and the ERROR transaction indicates that there has been an error.

The response provided by the hardware accelerator 22 may be in relation to any one or more of the set of command messages so that, if any one of the CMDNR messages in the set of messages contained an error, the hardware accelerator 22 can respond to the terminating CMD message with ERROR, even though the CMD message itself may not have contained an error.

### Programs and Systems for Implementing Examples Herein

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

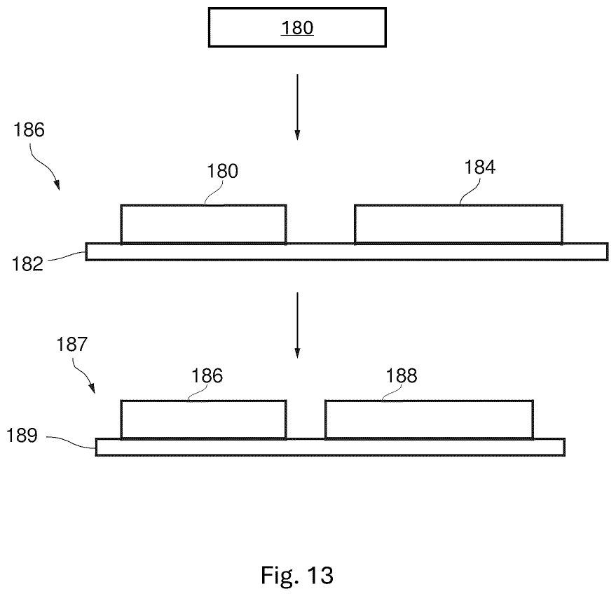

As shown in FIG. 13, one or more packaged chips 180, with a processor of any of the processors described above (e.g. the CPU 4, the hardware accelerator 22, or processing circuitry of the CPU 4 or hardware accelerator 22) implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Examples

Further examples are envisaged. It is to be appreciated that an apparatus otherwise the same as or similar to the apparatus 1 of FIG. 1 may include more than one hardware accelerator, and at least one of the hardware accelerators may be configured, based on an instruction generated by the processing circuitry 6, to perform a respective task, or to cooperate to perform a joint task (in the case of a plurality of hardware accelerators being configured by the instruction).

The CLAC registers 23 of FIG. 1 are an example of accelerator control interface storage for storing data for use by the accelerator control interface circuitry 14 for exchanging the messages with the hardware accelerator 22. In other examples, the accelerator control interface storage may be or comprise another form of storage than registers.

Although FIG. 4 shows the selected set of resource fields being sent using a resource message, in other cases, the selected set of resource fields may use at least one further resource message in addition to the resource message. In such cases, the processing circuitry 6 may determine how to distribute the selected set of resource fields across a set of resource messages.

FIGS. 10 and 11 illustrate the instruction for configuring the hardware accelerator 22 and the resource instruction as being stored in separate data structures 500, 600. However, in other examples, the instruction and the resource instruction may be stored in a (single) data structure. This may be the case for a set of tasks in which the resource instruction is expected to differ for different tasks of the set of tasks. In such cases, there may be a combined control field representing a combination of the control field and the resource control field. FIG. 11 illustrates an example in which there are four resource tables. However, in other examples, there may be a different number of resource tables than four.

Further examples are set out in the following numbered clauses:
1. An apparatus comprising:
   processing circuitry configured to generate an instruction for configuring a hardware accelerator to perform a task, wherein the instruction comprises a predefined set of fields comprising a control field indicative of a selected set of fields of the predefined set of fields to be provided to the hardware accelerator to configure the hardware accelerator to perform the task; and
   accelerator control interface circuitry configured to exchange messages, each with a size less than or equal to a predefined size, with the hardware accelerator,
   wherein, to configure the hardware accelerator to perform the task, the accelerator control interface circuitry is configured to send the selected set of fields to the hardware accelerator, using a set of command messages with a combined size greater than the predefined size.
2. The apparatus of clause 1, wherein the control field comprises a mask indicative of whether each field of the predefined set of fields is included in the selected set, on a per-field basis.
3. The apparatus of clause 1 or clause 2, wherein the processing circuitry is configured to generate a resource instruction indicative of resources to be used by the hardware accelerator to perform the task, and the accelerator control interface circuitry is configured to send a resource message to the hardware accelerator for configuring the hardware accelerator to use the resources to perform the task, wherein the resource message is based on the resource instruction.
4. The apparatus of clause 3, wherein the resource instruction comprises a predefined set of resource fields comprising a resource control field indicative of a selected set of resource fields of the predefined set of resource fields to be provided to the hardware accelerator for configuring the hardware accelerator to use the resources to perform the task, and the resource message comprises the selected set of resource fields.
5. The apparatus of any one of clauses 1 to 4, comprising accelerator control interface storage for storing data for use by the accelerator control interface circuitry for exchanging the messages with the hardware accelerator,
   wherein a bit-length of the predefined set of fields is greater than a storage size of the accelerator control interface storage.
6. The apparatus of any one of clauses 1 to 5, wherein the task comprises processing of a portion of a multi-dimensional tensor, and to generate the instruction, the processing circuitry is configured to:
   identify a coordinate range within a multi-dimensional space corresponding to the portion of the multi-dimensional tensor; and
   reset a lower bound of the coordinate range to a predefined value in at least one dimension of the multi-dimensional space to generate at least one adjusted lower bound,
   the predefined set of fields comprising at least one lower bound field indicative of a respective adjusted lower bound.
7. The apparatus of clause 6, wherein the predefined set of fields comprises at least one upper bound field indicative of a respective upper bound of the coordinate range in the at least one dimension.
8. The apparatus of clause 6 or clause 7, wherein the processing circuitry is configured to adjust a tensor descriptor defining the portion of the multi-dimensional tensor to compensate for resetting the lower bound of the coordinate range to a predefined value in the at least one dimension.
9. The apparatus of any one of clauses 1 to 8, wherein the task defines a multi-dimensional bounding box and, to generate the instruction, the processing circuitry is configured to:
   reset a lower bound and an upper bound of a given dimension of the multi-dimensional bounding box to a predefined value to indicate that the given dimension is unused in performing the task, thereby generating an adjusted bounding box,
   the predefined set of fields comprising a set of fields indicative of the adjusted bounding box.
10. The apparatus of any one of clauses 1 to 9, wherein a first size of a first message of the set of command messages is different from a second size of a second message of the set of command messages.
11. The apparatus of any one of clauses 1 to 10, wherein the processing circuitry is configured to generate the instruction to indicate that a predefined selected set of fields is comprised by the selected set of fields, the predefined selected set of fields comprising at least one of: the control field, a header field and a task field indicative of a task descriptor defining at least one operation for performing the task.
12. The apparatus of any one of clauses 1 to 11, wherein the set of command messages comprises:
   a command-without-response message indicating that the hardware accelerator does not need to acknowledge the command-without-response message; and, subsequently,
   a command-with-response message indicating that the hardware accelerator is to acknowledge the command-with-response message.
13. The apparatus of any one of clauses 1 to 12, wherein the task comprises a plurality of operations representable as a directed graph of operations comprising operations connected by connections corresponding to respective logical storage locations.
14. A system comprising:
   the apparatus of any one of clauses 1 to 13, implemented in at least one packaged chip;
   at least one system component; and
   a board,
wherein the at least one packaged chip and the at least one system component are assembled on the board.
15. A chip-containing product comprising the system of clause 14, wherein the system is assembled on a further board with at least one other product component.
16. A non-transitory computer-readable medium having stored thereon computer-readable code for fabrication of the apparatus of any one of clauses 1 to 13.
17. A hardware accelerator comprising:
   accelerator processing circuitry configurable to perform a task on behalf of a processor; and
   control interface circuitry configured to exchange messages, each with a size less than or equal to a predefined size, with the processor,
   wherein the control interface circuitry is configured to receive, from the processor, a set of command messages with a combined size greater than the predefined size; and
   the accelerator processing circuitry is configured to:
      obtain, from the set of command messages, a selected set of fields of a predefined set of fields of an instruction to configure the hardware accelerator to perform the task, the selected set of fields comprising a control field indicative of which fields of the predefined set of fields are included in the selected set of fields; and
      reconstruct the instruction from the set of command messages, based on the control field, to obtain a reconstructed instruction.
18. The hardware accelerator of clause 17, wherein the control field comprises a mask indicative of whether each field of the predefined set of fields is included in the selected set, on a per-field basis.
19. The hardware accelerator of clause 17 or clause 18, wherein the set of command messages comprises:
   a first message comprising the control field; and
   a second message, subsequent to the first message, and
   the accelerator processing circuitry is configured to use the control field of the first message to determine which fields of the predefined set of fields are included in the first message and the second message.
20. The hardware accelerator of any one of clauses 17 to 19, wherein the control interface circuitry is configured to receive a resource message indicative of resources to be used by the hardware accelerator to perform the task, and the accelerator processing circuitry is configured to, based on the resource message, use the resources to perform the task.
21. The hardware accelerator of clause 20, wherein the accelerator processing circuitry is configured to:
   obtain, from the resource message, a selected set of resource fields of a predefined set of resource fields of a resource instruction to configure the hardware accelerator to use the resources to perform the task, the selected set of resource fields comprising a resource control field indicative of which fields of the predefined set of resource fields are included in the selected set of resource fields; and
   reconstruct the resource instruction from the resource message, based on the resource control field, to obtain a reconstructed resource instruction.
22. The hardware accelerator of clause 20 or clause 21, wherein the task is a first task and the accelerator processing circuitry is configured to use the resources indicated by the resource message to perform a second task subsequent to the first task.
23. The hardware accelerator of any one of clauses 17 to 22, wherein the task defines a multi-dimensional bounding box, and the accelerator processing circuitry is configured to:
   determine, based on the reconstructed instruction, that a lower bound and an upper bound of a given dimension of the multi-dimensional bounding box are each a predefined value; and,
   in response, omit iteration over the given dimension in performing the task.
24. The hardware accelerator of any one of clauses 17 to 23, wherein the hardware accelerator is a neural network accelerator and the task comprises at least a portion of a neural processing operation.
25. A system comprising:
   the hardware accelerator of any one of clauses 17 to 24, implemented in at least one packaged chip;
   at least one system component; and
   a board,
wherein the at least one packaged chip and the at least one system component are assembled on the board.
26. A chip-containing product comprising the system of clause 25, wherein the system is assembled on a further board with at least one other product component.
27. A non-transitory computer-readable medium having stored thereon computer-readable code for fabrication of the hardware accelerator of any one of clauses 17 to 24.
28. A method implemented by an apparatus comprising processing circuitry, the method comprising:
   generating an instruction for configuring a hardware accelerator to perform a task, wherein the instruction comprises a predefined set of fields comprising a control field indicative of a selected set of fields of the predefined set of fields to be provided to the hardware accelerator to configure the hardware accelerator to perform the task; and
   sending the selected set of fields to the hardware accelerator, based on the instruction, using a set of command messages with a combined size greater than the predefined size.
29. The method of clause 28, comprising:
   generating a resource instruction indicative of resources to be used by the hardware accelerator to perform the task; and
   sending a resource message to the hardware accelerator for configuring the hardware accelerator to use the resources to perform the task.
30. A method implemented by a hardware accelerator, the method comprising:
   receiving, from a processor, a set of command messages with a combined size greater than a predefined size, wherein the hardware accelerator is configured to exchange messages, each with a size less than or equal to a predefined size, with the processor;
   obtaining, from the set of command messages, a selected set of fields of a predefined set of fields of an instruction to configure the hardware accelerator to perform a task, the selected set of fields comprising a control field indicative of which fields of the predefined set of fields are included in the selected set of fields; and
   reconstructing the instruction from the set of command messages, based on the control field, to obtain a reconstructed instruction.
31. The method of clause 30, wherein the set of command messages comprises:
   a first message comprising the control field; and
   a second message, subsequent to the first message, and
   the method comprises using the control field of the first message to determine which fields of the predefined set of fields are included in the first message and the second message.

What is claimed is:

1. An apparatus comprising:
processing circuitry configured to generate an instruction for configuring a hardware accelerator to perform a task, wherein the instruction comprises a predefined set of fields comprising a control field indicative of a selected set of fields of the predefined set of fields to be provided to the hardware accelerator to configure the hardware accelerator to perform the task; and
accelerator control interface circuitry configured to exchange messages, each with a size less than or equal to a predefined size, with the hardware accelerator,
wherein, to configure the hardware accelerator to perform the task, the accelerator control interface circuitry is configured to send the selected set of fields to the hardware accelerator, using a set of command messages with a combined size greater than the predefined size.

2. The apparatus of claim 1, wherein the control field comprises a mask indicative of whether each field of the predefined set of fields is included in the selected set, on a per-field basis.

3. The apparatus of claim 1, wherein the processing circuitry is configured to generate a resource instruction indicative of resources to be used by the hardware accelerator to perform the task, and the accelerator control interface circuitry is configured to send a resource message to the hardware accelerator for configuring the hardware accelerator to use the resources to perform the task, wherein the resource message is based on the resource instruction.

4. The apparatus of claim 3, wherein the resource instruction comprises a predefined set of resource fields comprising a resource control field indicative of a selected set of resource fields of the predefined set of resource fields to be provided to the hardware accelerator for configuring the hardware accelerator to use the resources to perform the task, and the resource message comprises the selected set of resource fields.

5. The apparatus of claim 1, comprising accelerator control interface storage for storing data for use by the accelerator control interface circuitry for exchanging the messages with the hardware accelerator,
wherein a bit-length of the predefined set of fields is greater than a storage size of the accelerator control interface storage.

6. The apparatus of claim 1, wherein the task comprises processing of a portion of a multi-dimensional tensor, and to generate the instruction, the processing circuitry is configured to:
identify a coordinate range within a multi-dimensional space corresponding to the portion of the multi-dimensional tensor; and
reset a lower bound of the coordinate range to a predefined value in at least one dimension of the multi-dimensional space to generate at least one adjusted lower bound,
the predefined set of fields comprising at least one lower bound field indicative of a respective adjusted lower bound.

7. The apparatus of claim 6, wherein the predefined set of fields comprises at least one upper bound field indicative of a respective upper bound of the coordinate range in the at least one dimension.

8. The apparatus of claim 6, wherein the processing circuitry is configured to adjust a tensor descriptor defining the portion of the multi-dimensional tensor to compensate for resetting the lower bound of the coordinate range to a predefined value in the at least one dimension.

9. The apparatus of claim 1, wherein the task defines a multi-dimensional bounding box and, to generate the instruction, the processing circuitry is configured to:
reset a lower bound and an upper bound of a given dimension of the multi-dimensional bounding box to a predefined value to indicate that the given dimension is unused in performing the task, thereby generating an adjusted bounding box,
the predefined set of fields comprising a set of fields indicative of the adjusted bounding box.

10. The apparatus of claim 1, wherein a first size of a first message of the set of command messages is different from a second size of a second message of the set of command messages.

11. The apparatus of claim 1, wherein the processing circuitry is configured to generate the instruction to indicate that a predefined selected set of fields is comprised by the selected set of fields, the predefined selected set of fields comprising at least one of: the control field, a header field and a task field indicative of a task descriptor defining at least one operation for performing the task.

12. A system comprising:
the apparatus of claim 1, implemented in at least one packaged chip;
at least one system component; and
a board,
wherein the at least one packaged chip and the at least one system component are assembled on the board.

13. A hardware accelerator comprising:
accelerator processing circuitry configurable to perform a task on behalf of a processor; and
control interface circuitry configured to exchange messages, each with a size less than or equal to a predefined size, with the processor,
wherein the control interface circuitry is configured to receive, from the processor, a set of command messages with a combined size greater than the predefined size; and
the accelerator processing circuitry is configured to:
obtain, from the set of command messages, a selected set of fields of a predefined set of fields of an instruction to configure the hardware accelerator to perform the task, the selected set of fields comprising a control field indicative of which fields of the predefined set of fields are included in the selected set of fields; and
reconstruct the instruction from the set of command messages, based on the control field, to obtain a reconstructed instruction.

14. The hardware accelerator of claim 13, wherein the control field comprises a mask indicative of whether each field of the predefined set of fields is included in the selected set, on a per-field basis.

15. The hardware accelerator of claim 13, wherein the set of command messages comprises:
a first message comprising the control field; and
a second message, subsequent to the first message, and
the accelerator processing circuitry is configured to use the control field of the first message to determine which fields of the predefined set of fields are included in the first message and the second message.

16. The hardware accelerator of claim 13, wherein the control interface circuitry is configured to receive a resource message indicative of resources to be used by the hardware accelerator to perform the task, and the accelerator processing circuitry is configured to, based on the resource message, use the resources to perform the task.

17. The hardware accelerator of claim 16, wherein the accelerator processing circuitry is configured to:
obtain, from the resource message, a selected set of resource fields of a predefined set of resource fields of a resource instruction to configure the hardware accelerator to use the resources to perform the task, the selected set of resource fields comprising a resource control field indicative of which fields of the predefined set of resource fields are included in the selected set of resource fields; and
reconstruct the resource instruction from the resource message, based on the resource control field, to obtain a reconstructed resource instruction.

18. The hardware accelerator of claim 16, wherein the task is a first task and the accelerator processing circuitry is configured to use the resources indicated by the resource message to perform a second task subsequent to the first task.

19. The hardware accelerator of claim 13, wherein the task defines a multi-dimensional bounding box, and the accelerator processing circuitry is configured to:
determine, based on the reconstructed instruction, that a lower bound and an upper bound of a given dimension of the multi-dimensional bounding box are each a predefined value; and,
in response, omit iteration over the given dimension in performing the task.

20. A system comprising:
the hardware accelerator of claim 14, implemented in at least one packaged chip;
at least one system component; and
a board,
wherein the at least one packaged chip and the at least one system component are assembled on the board.
